(19) United States
(12) Patent Application Publication
(10) Pub. No.: US 2013/0260299 A1
(43) Pub. Date: Oct. 3, 2013

(54) IMAGE FORMING METHOD AND IMAGE FORMING APPARATUS

(71) Applicants: Hisashi NAKAJIMA, Shizuoka (JP); Masashi Nagayama, Shizuoka (JP); Saori Yamada, Shizuoka (JP); Mariko Takii, Kanagawa (JP)

(72) Inventors: Hisashi NAKAJIMA, Shizuoka (JP); Masashi Nagayama, Shizuoka (JP); Saori Yamada, Shizuoka (JP); Mariko Takii, Kanagawa (JP)

(21) Appl. No.: 13/799,862

(22) Filed: Mar. 13, 2013

(30) Foreign Application Priority Data
Mar. 29, 2012 (JP) 2012-076173

(51) Int. Cl. G03G 9/00; G03G 15/20; G03G 15/08

(52) U.S. Cl. CPC G03G 15/2064
USPC 430/105; 399/329; 399/252

(57) ABSTRACT

An image forming method including steps of forming a latent electrostatic image on an image bearing member, developing the latent electrostatic image with a development agent containing toner to obtain a toner image; transferring the toner image onto a transfer medium; fixing the toner image thereon; wherein the fixing is executed by a fixing device containing a heating roller; a fixing roller; a toner heating medium and the fixing roller; and a pressure roller wherein the toner contains a toner binder containing a crystalline resin containing a polyester resin A; a non-crystalline resin containing a non-crystalline resin B and a non-crystalline resin C, and a complex resin, wherein the toner has a main peak in a range of from 1,000 to 10,000 in the molecule weight distribution as measured for a component soluble in tetrahydrofuran by gel permeation chromatography with a half value width of 15,000 or less.

### CROSS-REFERENCE TO RELATED APPLICATIONS

This patent application is based on and claims priority pursuant to 35 U.S.C. §119 to Japanese Patent Application No. 2012-076173, filed on Mar. 29, 2012 in the Japan Patent Office, the entire disclosure of which is hereby incorporated by reference herein.

### BACKGROUND

1. Field

The present invention relates to an image forming method and an image forming apparatus executing the same.

2. Description of the Background

The demand for energy-saving and faster image forming apparatuses such as printers, photocopiers, and facsimile machines is increasing from the market. Improving the heat efficiency of the fixing device for use in the image forming apparatus is one way to respond to such demand.

In image forming apparatuses, unfixed toner images are formed on recording media such as sheets, printing paper, photosensitive paper, and electrostatic recording paper in an image transfer system or a direct system by the image forming processes such as electrophotography, electrostatic recording, and magnetic recording.

Such unfixed toner images are typically fixed by a fixing device employing a contact heating system such as a heating roller system, a film heating system, and an electromagnetic induction heating system.

The fixing device of a heating roller system basically includes a pair of rotatable rollers formed of a heating and fixing roller having a heat source such as a halogen lamp inside to adjust the temperature desirably and a pressure roller pressed to the heating and fixing roller.

The recording medium is fed into the contact portion of the rotatable rollers, so called fixing nipping portion, where the unfixed toner image is melted and fixed by the heat and the pressure from the heating and fixing roller and the pressure roller.

JP-S63-313182-A and JP-H1-263679-A disclose fixing devices of the film heating system which supplies heat by a heating element fixedly supported by a supporting member.

The heating element is tightly in contact with a recording medium via a heat-resistant thin fixing film that slides against the heating element.

This fixing device uses, for example, a ceramic heater formed of a ceramic substrate such as alumina or aluminum nitride having properties such as heat resistance, insulation property, and thermal conductance and a resistance layer on the ceramic substrate as the heating element.

This fixing device uses a thin film having a low thermal capacity as the fixing film, so that it is better than the fixing device of the heating roller system with regard to the heat conduction and the warm-up period.

Consequently, this is advantageous to achieve a quick start and energy-saving.

As an example of the fixing device of the electromagnetic induction heating system, JP-H8-22206 discloses a system heating a heating element containing a magnetic metal part by Joule heat generated by an eddy current caused by an alternating magnetic field.

The configuration of the fixing device employing the electromagnetic induction heating system is as follows.

FIG. 1 is a schematic diagram illustrating a typical fixing device employing the electromagnetic induction heating system.

As illustrated in FIG. 1, the typical fixing device has a configuration of a film inside guide 21 to which a heating element 20 formed of an exciting coil unit 18 and a magnetic metal element 19 serving as a heating unit is attached, a cylindrical film 17 having a heat resistance that encloses the film inside guide 21 in contact with the magnetic metal element 19, and a pressure roller 22 to rotate the cylindrical film 17 while forming a nipping portion N in contact with the cylindrical film 17 with a pressure to the cylindrical film 17 at the position of the magnetic metal element 19.

The cylindrical film 17 is a heat-resistant single layer film of polytetra fluoroethylene (PTFE), perfluoroalkoxy (PFA), a fluorine resin copolymerized from teterfluoroethylene and hexafluoroproplylene (FEP), etc. with a thickness of 100 μm or less, preferably from 20 μm to 50 μm.

In the alternative, it is possible to use a complex layer film in which the exterior surface of the film of polyimide, polyamideimine, polyetheretherketone (PEEK), poly ether sulfone (PES), poly phenylene sulfide (PPS), etc. is coated with PTFE, PFA, FEP, etc.

Moreover, the film inside guide 21 is formed of a rigid and heat-resistant member made of a resin such as PEEK, PPS, etc. and the heating member 20 is fit into the significantly center portion of the longitudinal direction of the film inside guide 21.

The pressure roller 22 has a core 22a and a heat-resistant rubber layer 22b such as silicone rubber having a good releasability formed around the core 22a and is arranged to be pressed to the magnetic metal part element 19 of the heating element 20 with the cylindrical film 17 therebetween by a predetermined force from a bearing and a biasing device. The pressure roller 22 is rotated counterclockwise by a driving device.

Due to the rotation driving of the pressure roller 22, friction occurs between the pressure roller 22 and the cylindrical film 17 to apply the rotation force to the cylindrical film 17. The cylindrical film 17 slidably rotates while tightly in contact with the magnetic metal part element 19 of the heating element 20.

When the heating element 20 reaches the predetermined temperature, a recording medium 11 on which an unfixed toner image T is formed at the image forming portion is fed between the film 17 of the fixing nipping portion.

When the recording medium 11 is transferred to the fixing nipping portion N while being sandwiched between the pressure roller 22 and the film 17, the heat of the magnetic metal member 19 is conveyed to the recording medium 11 via the film 17, so that the unfixed toner image T is melted and fixed on the recording medium 11.

At the exit of the fixing nipping portion N, the recording medium 11 is separated from the surface of the cylindrical film 17 and transferred to a discharging tray.

In such a fixing device employing the electromagnetic induction heating system, the magnetic metal part element 19 serving as the induction heating device can be arranged close to the unfixed toner image T on the recording medium via the cylindrical film 17 by using the generation of the eddy current, which improves the heating efficiency better than the fixing device of the film heating system.

Furthermore faster image forming apparatuses are demanded, which requires a shorter heating time during fixing of the unfixed toner image.

In cases of full color image forming apparatuses in particular, the capability of sufficiently heating and melting full color thick toner images having four or more layers in a short time is demanded.

However, to heat and melt the toner image evenly by sufficient enclosure, a rubber elastic layer having a certain thickness is provided on the surface of the film to secure the nipping width.

This elastic layer has a low thermal conduction, thereby degrading the heat response, which makes fast image forming difficult and results in failure of enjoying the energy-saving achieved by the electromagnetic induction heating system.

JP-2005-173445-A and JP-2005-173446-A disclose image forming apparatuses striking a balance between high speed image forming and energy saving in which a fixing roller having an elastic layer and a pressure roller having an elastic layer form a nipping portion via a fixing belt.

The fixing belt is heated by the heating roller heated by the heat generated by electromagnetic induction, thereby securing the nipping width even for a thin fixing belt.

However, the fixing belt for use in this image forming apparatus has a small heat capacity.

When forming an image requiring a large quantity of toner, the belt temperature drops sharply, that is, failure to secure the fixing performance, which leads to a peculiar problem of so-called cold offset.

On the other hand, for example, there is a known method of improving the fixing performance of the toner by controlling, thermal characteristics such as the glass transition temperature Tg and the softening temperature T1/2 of the toner binder resin. However, a low Tg of the resin causes deterioration of the high temperature stability and a low T1/2 achieved by decreasing the molecular weight of the resin, etc. causes problems of hot offset, etc.

Therefore, although successful in some degree, toner having good properties about all the low temperature fixability, the high temperature stability and the hot offset resistance has not obtained yet.

In attempts to meet the demand for the low temperature fixing, JP S60-90344-A, JP-S64-15755-A, JP-H2-82267-A, JP-H3-229264-A, JP-H3-41470-A, and JP-H11-305486-A disclose using polyester resins, which have an excellent low temperature fixability and a relatively good high temperature stability, instead of typically used styrene-acrylic resins.

In addition, JP-S62-63940-A discloses adding a particular non-olefin crystalline polymer having a sharp melt property at the glass transition temperature to a binder resin targeted to improve the low temperature fixability.

However, it is not successful in terms of the optimization of the molecular structure and the molecular weight.

JP-2931899-B1 (JP-H11-249339-A) and JP-2001-222138-A disclose using a crystalline polyester having the same sharp melt property as the particular non-olefin crystalline polymer mentioned above for the toner to improve the fixability.

However, the toner using the crystalline polyester disclosed in JP-2931899-B1 (JP-H11-249339-A) mentioned above has a low acid value and a low hydroxyl value, i.e., 5 or less and 20 or less, respectively, so that the paper and the crystalline polyester have low affinity, resulting in insufficient low temperature fixability.

The toner using the crystalline polyester disclosed in JP-2001-222138-A mentioned above is not clear about the optimization of the molecular weight of the finally-obtained toner and the existence state of the crystalline polyester.

As a consequence, the toner using the crystalline polyester disclosed in JP-2001-222138-A mentioned above may not sufficiently exhibit excellent low temperature fixability and high temperature stability ascribable to the crystallinity after the toner is actually made.

Moreover, the toner does not have any measure to the hot offset resistance so that a sufficiently wide temperature range is not secured for fixing to obtain quality images.

JP-2004-46095-A discloses a sea-island phase separation structure of a crystalline polyester resin and a non-crystalline polyester resin incompatible therewith.

The toner disclosed in JP-2004-46095-A mentioned above uses three kinds of resins containing the crystalline polyester resin. To maintain this sea-island phase separation structure of the crystalline polyester resin, the dispersion diameter of the crystalline polyester resin becomes excessively large, which leads to degradation of the high temperature stability or a transfer problem in the transfer process ascribable to an excessively low electric resistance. As a result, the image quality tends to deteriorate.

JP-2007-33773-A discloses improving the low temperature fixability and the high temperature stability of toner by regulating the endothermic amount of the peak appearing on the endothermic side in a differential scanning calorimetry (DSC) curve measured by a differential scanning calorimeter to control the existence state of the crystalline polyester resin.

This toner assumes using a resin having a relatively high softening point as the non-crystalline polyester resin which is used in combination with the crystalline resin.

The low temperature fixability is secured by the crystalline polyester resin, thereby naturally increasing the amount thereof.

Consequently, this increases the possibility of deterioration of the high temperature stability due to the compatibility with the non-crystalline resin.

JP-2005-338814-A discloses toner containing a large quantity of the crystalline polyester resin. However, since the amount of the crystalline polyester resin is excessively large, it is highly probable that the high temperature stability deteriorates due to the compatibility with the non-crystalline resin.

JP-4118498-B1 (JP-2002-082484-A) discloses regulating the peak and the half value width of the molecular weight distribution of the toner and the amount of the component insoluble in chloroform and using two or more kinds of resins having different softening points as the binder resins.

However, since no crystalline polyester resin is used, the low temperature fixability does not suffice in comparison with a case in which a crystalline polyester resin is used. In spite of these various attempts to improve the low temperature fixability of toner, toner has not been obtained yet which can be fixed by the fixing devices disclosed in JP-2005-173445-A and JP-2005-173446-A mentioned above and has an excellent high temperature stability and hot offset resistance.

### SUMMARY

The present invention provides an image forming method including steps of: forming a latent electrostatic image on an image bearing member; developing the latent electrostatic image with a development agent containing toner to obtain a toner image; transferring the toner image onto a transfer medium; fixing the toner image on the transfer medium; wherein the step of fixing is executed by a fixing device having a heating roller; a fixing roller having an elastic layer, which is arranged in parallel with the heating roller; a toner heating medium having an endless form stretched around the heating roller and the fixing roller; and a pressure roller having an elastic layer, which presses the fixing roller via the toner heating medium and while rotating to form a nipping portion with the fixing roller, wherein the toner contains a toner binder containing a crystalline resin containing a polyester resin A having a crystallinity; a non-crystalline resin containing a non-crystalline resin B containing a component insoluble in chloroform; and a non-crystalline resin C having a softening point (T1/2) 25° C. or more lower than that of the non-crystalline resin B; and a complex resin containing a complex resin D containing a condensation polymerization resin unit; and an addition polymerization resin unit, wherein the toner has a main peak in a range of from 1,000 to 10,000 in a molecule weight distribution as measured for a component soluble in tetrahydrofuran (THF) by gel permeation chromatography (GPC) with a half value width of 15,000 or less.

As another aspect of the present invention, an image forming apparatus including an image bearing member to bear a latent electrostatic image; an irradiator to irradiate the image bearing member to form the latent electrostatic image thereon; a development device to develop the latent electrostatic image with a development agent containing toner to obtain a toner image; a transfer device to transfer the toner image onto a transfer medium; and a fixing device to fix the toner image on the transfer medium; wherein the fixing device has a heating roller; a fixing roller having an elastic layer, which is arranged in parallel with the heating roller; a toner heating medium having an endless form stretched around the heating roller and the fixing roller; and a pressure roller having an elastic layer, which presses the fixing roller via the toner heating medium while rotating to form a nipping portion with the fixing roller, wherein the toner contains a toner binder containing a crystalline resin containing a polyester resin A having a crystallinity; a non-crystalline resin containing a non-crystalline resin B containing a component insoluble in chloroform; and a non-crystalline resin C having a softening point (T1/2) 25° C. or more lower than that of the non-crystalline resin B; and a complex resin containing a complex resin D containing a condensation polymerization resin unit; and an addition polymerization resin unit, wherein the toner has a main peak in a range of from 1,000 to 10,000 in a molecule weight distribution as measured for a component soluble in tetrahydrofuran (THF) by gel permeation chromatography (GPC) with a half value width of 15,000 or less.

### BRIEF DESCRIPTION OF THE DRAWINGS

Various other objects, features, and attendant advantages of the present invention will be more fully appreciated as the same become better understood from the detailed description when considered in connection with the accompanying drawings, in which like reference characters designate like corresponding parts throughout and wherein

FIG. 1 is a schematic diagram illustrating a typical fixing device employing the electromagnetic induction heating system;

FIG. 2 is a schematic diagram illustrating an example of the fixing device of the present disclosure;

FIGS. 3A and 3B are schematic diagrams illustrating an example of the exciting coil;

FIG. 4 is a graph illustrating the result of X-ray diffraction of crystalline resin a6 for use in Examples described later;

FIG. 5 is a graph illustrating an example of the X-ray diffraction result of the toner obtained in Example 35 described later;

FIG. 6 is a schematic diagram illustrating an example of the development device for use in the present disclosure;

FIG. 7 is a schematic diagram illustrating an example of the development device for use in the present disclosure;

FIG. 8 is a diagram illustrating an example of the image forming apparatus having the development device of FIG. 7;

FIG. 9 is a schematic diagram illustrating another example of the image forming apparatus of the present disclosure; and

FIG. 10 is a schematic diagram illustrating an example of the process cartridge of the present disclosure.

### DETAILED DESCRIPTION

The image forming method and the image forming apparatus of the present disclosure are described in detail.

The image forming method includes a process of forming a latent electrostatic image on an image bearing member, a process of forming a toner image by developing with a development agent containing toner for electrostatic image development, a process of transferring the toner image to a transfer medium; and a process of fixing the toner image on the transfer medium.

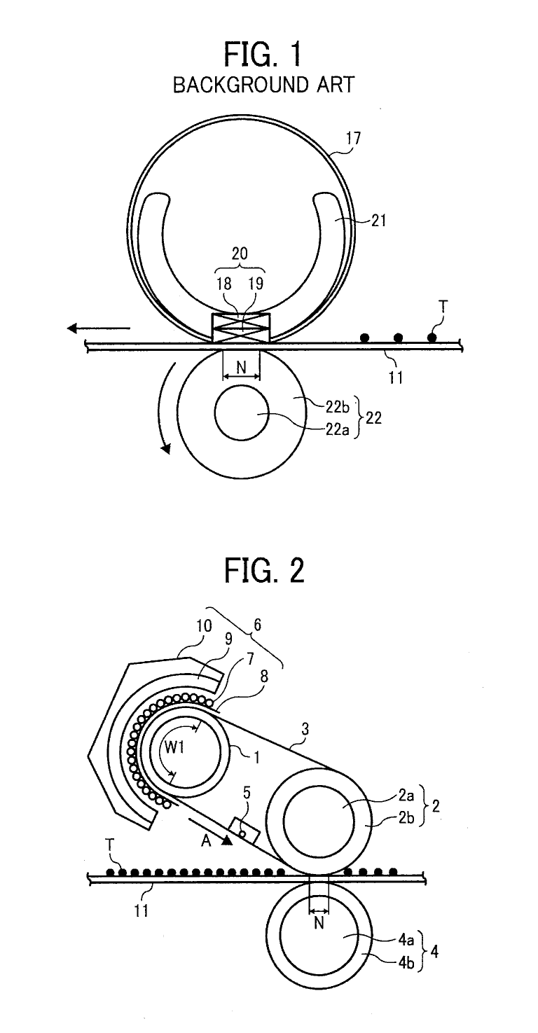

FIG. 2 is a diagram illustrating an example of the fixing device of the present disclosure. In FIG. 2, the fixing device includes a heating roller 1 heated by a heating device 6, a fixing roller 2 arranged in parallel with the heating roller 1, a heat-resistant endless belt (toner heating medium) 3 stretched between the heating roller 1 and the fixing roller 2, which rotates in the direction A indicated by the arrow in FIG. 2 by the rotation of the rollers, and a pressure roller 4 that is pressed to the fixing roller 2 via the heat-resistant endless belt 3.

It is preferable that the heating device 6 directly generates heat in a heat generating material such as a heating roller and/or a heat-resistant endless belt by electromagnetic induction. If the heat generating material directly generates heat by electromagnetic induction, it is possible to heat only the electroconductive member.

Since members not to be heated are not heated, the heat conversion efficiency is high in comparison with the heater lamp heating system.

For this reason, it is possible to raise the temperature of the surface of the fixing roller and the heat-resistant endless belt to the fixing temperature quickly with less electric power.

The heating roller 1 is formed of a magnetic metal material having a hollow cylinder form made of iron, cobalt, nickel, or alloyed metal thereof.

For example, the heating roller 1 has an exterior diameter of 20 mm and a thickness of 0.1 mm so that the temperature rising speed is fast because it has a low heat capacity.

The fixing roller 2 is formed of a core metal 2a made of metal such as stainless steel and an elastic material 2b covering the core metal 2a by using a solid or foam heat-resistant silicone rubber.

To form a contact portion having a predetermined width between the pressure roller 4 and the fixing roller 2 under the pressure from the pressure roller 4, the fixing roller 2 has an exterior diameter of about 40 mm and is greater than the heating roller 1.

The elastic material 2b has a thickness of from about 3 mm to about 6 mm with a hardness of from about 40° to about 60° (as measured in Asker hardness).

In this configuration, the heat capacity of the heating roller 1 is smaller than that of the fixing roller 2 so that the heating roller 1 is rapidly heated, thereby shortening the warm-up period.

The heat-resistant endless belt 3 stretched around the heating roller 1 and the fixing roller 2 is heated at a contact portion W1 with the heating roller 1 heated by the heating device 6.

Thereafter, the heat-resistant endless belt 3 is continuously heated by the rotation of the rollers 1 and 2, so that the belt is heated entirely.

The heat-resistant endless belt 3 has a substrate and a releasing layer. The thickness of the releasing layer is preferably from about 50 μm to 500 μm and more preferably from about 150 μm to 250 μm.

Due to the releasing layer, the heat-resistant endless belt 3 encloses sufficiently the toner image T formed on a recording medium 11.

Coupled with the fixing roller having an elastic layer and the pressure roller having an elastic layer, the toner image T is heated and melted evenly.

When the thickness of the releasing layer is too thin, the heat capacity of the heat-resistant endless belt 3 tend to decrease.

The temperature at the surface of the belt drops sharply in the toner fixing process, thereby failing to secure the fixing performance sufficiently.

Moreover, when the thickness of the releasing layer is too thick, the heat capacity of the heat-resistant endless belt 3 increases, which results in a long warm-up period.

In addition, in the toner fixing process, the temperature at the surface of the belt does not easily fall, the agglomeration effect of the melted toner at the exit of the fixing unit is not obtained.

Consequently, the releasability of the belt tends to deteriorate, causing the toner to adhere to the belt, which is so-called hot offset.

The substrate can be made of a heat-resistant resin such as a fluorine-containing resin, a polyimide resin, a polyamide resin, a polyamideimide resin, a PEEK resin, a PES resin, and a PPS resin.

If the substrate is formed of a magnetic metal generating heat by electromagnetic induction, the substrate serves as a heat-generating layer, resulting in heat generation of the belt itself, which is preferable.

The pressure roller 4 is formed of, for example, a core metal 4a having a cylinder-like form made of a highly thermal-conductive metal such as copper or aluminum and a heat-resistant elastic material 4b having a high toner releasability, which is provided on the surface of the core metal 4a.

The core metal 4a can be made of SUS other than the metals specified above.

The pressure roller 4 forms a fixing nipping portion N by pressing the fixing roller 2 via the heat-resistant endless belt 3.

In this embodiment, the pressure roller 4 is harder than the fixing roller 2.

Therefore, the pressure roller 4 digs into the fixing roller 2 and the heat-resistant endless belt 3, so that the recording medium 11 moves along the circumference form of the surface of the pressure roller 4 and is easily detached from the surface of the heat-resistant endless belt 3.

The exterior diameter of the pressure roller 4 is about 40 mm, which is the same as that of the fixing roller 2.

The thickness of the pressure roller 4 is from about 1 mm to about 3 mm, which is less than that of the fixing roller 2.

The hardness of the pressure roller 4 is from about 50° to about 70° (as measured in Asker hardness), which is greater than that of the fixing roller 2, as described above.

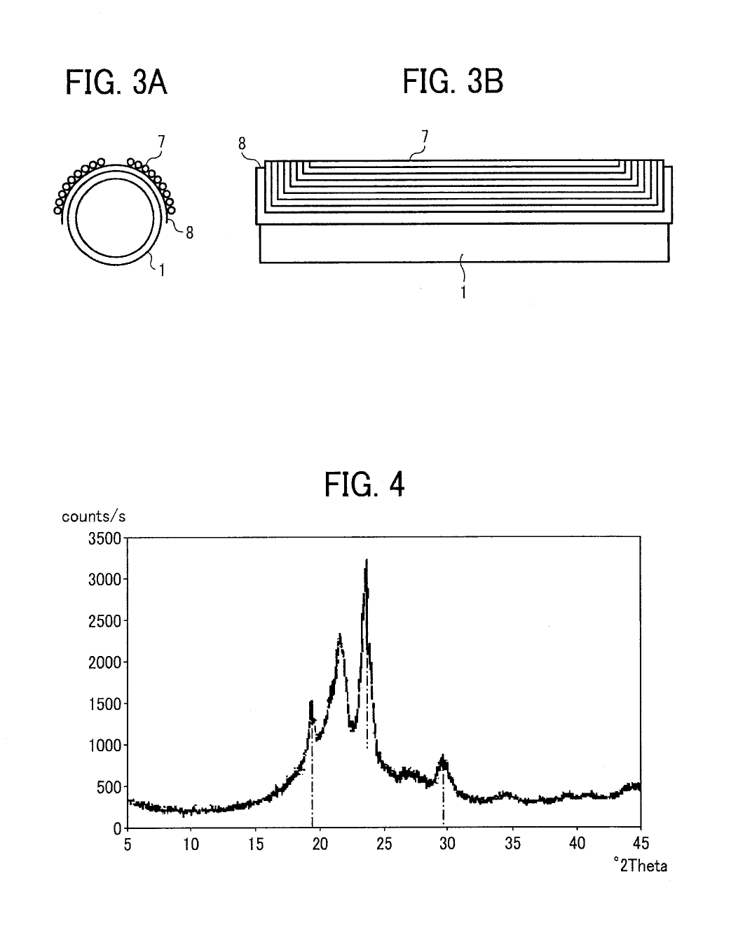

The heating device 6 to heat the heating roller 1 and/or the heat-resistant endless belt 3 by electromagnetic induction has an exciting coil 7 serving as the magnetic field generating device and a coil guide board 8 round which the exciting coil 7 is wound as illustrated in FIGS. 2, 3A, and 3B.

The coil guide board 8 has a semi-circle-like form, arranged close to the exterior surface of the heating roller 1.

As illustrated in FIG. 3B, the exciting coil 7 is formed by alternately winding a long exciting coil line material round along the coil guide board 8 in the axis direction of the heating roller 1.

The exciting coil 7 is connected to a driving power source having a frequency-variable oscillation circuit.

Outside the exciting coil 7, an exciting coil core 9 having a semi-circle-like form, which is made of a strong magnetic substance such as ferrite is arranged close to the exciting coil 7 while fixed to an exciting coil supporting member 10.

In this embodiment, the exciting coil core 9 has a specific magnetic permeability of 2,500.

A high frequency alternate current of from 10 kHz to 1 MHz, preferably from 20 kHz to 800 kHz, is applied to the exciting coil 7 from the driving power source to generate an alternating magnetic field.

This alternating magnetic field works on the heating roller 1 and/or the substrate (heat generating layer) of the heat-resistant endless belt 3 at a contact area W1 between the heating roller 1 and the heat-resistant endless belt 3 and therearound.

The eddy current flows inside the heating roller 1 and/or the heat generating layer 3 in the direction against the change of the alternating magnetic field.

This eddy current generates Joule heat according to the resistances of the heating roller 1 and/or the substrate (heat generating layer) of the heat-resistant endless belt 3, thereby heating the heating roller 1 and the heat-resistant endless belt 3 having the substrate (heat generating layer) mainly at the contact area between the heating roller 1 and the heat-resistant endless belt 3 as a result of electromagnetic induction.

The temperature inside the thus-heated heat-resistant endless belt 3 is detected by a temperature detector 5 formed of a thermosensor having an excellent response such as a thermistor arranged in contact with the heat-resistant endless belt 3 on the interior side thereof at an area close to the entrance of the fixing nipping portion N.

The toner for use in the present disclosure is described next.

The toner for use in combination with the fixing device described above is required to have a low temperature fixability.

Toner having a low temperature fixability can be obtained by simply lowering the softening temperature (T1/2) of the toner binder.

However, it the softening temperature lowers, the glass transition temperature lowers, which results in deterioration of the high temperature stability.

In addition, as the lower limit of the fixing temperature (lowest fixing temperature) below which a problem occurs to the image quality lowers, the upper limit (highest fixing temperature) above which fixing is not possible lowers.

As a result, the hot offset resistance deteriorates and also the high temperature stability deteriorates.

Striking a balance among the three, which are the low temperature fixability, the high temperature stability, and the hot offset resistance, is an extremely difficult issue for a man in the art to design the toner for electrophotography.

The present inventors made an investigation about this issue and found that quality images having excellent hot offset resistance without smear ascribable to poor fixing performance can be formed by using toner that has a toner binder containing a crystalline resin, a non-crystalline resin, and a complex resin while achieving less energy consumption by the fixing device.

The crystalline resin is a polyester resin A having a crystallinity and the non-crystalline resin contains a non-crystalline resin B containing a component insoluble in chloroform and a non-crystalline resin having a softening temperature (T1/2) 25° C. or more lower than that of the non-crystalline resin B.

The complex resin is a complex D containing a condensation polymerization resin unit and an addition polymerization resin unit.

The toner has the main peak in a range of from 1,000 to 10,000 of a molecular weight distribution obtained from the component soluble in tetrahydrofuran as measured by GPC with a half width value of the molecular weight distribution of 15,000 or less.

The toner binder for use in the present disclosure is described next.

By using the crystalline polyester A, the toner binder imparts the toner with the low temperature fixability and the high temperature stability due to the sharp melt deriving from its crystallinity.

However, a simple use of the crystalline polyester A as the toner binder significantly degrades the hot offset resistance.

As a result, the obtained toner has an extremely narrow fixing temperature range and is not practically usable.

By using the non-crystalline resin B containing a component insoluble in chloroform in combination with the crystalline polyester resin A, the hot offset resistance is improved to have a wide fixable temperature range.

However, if simply using the crystalline polyester A and the non-crystalline resin B, as the non-crystalline resin B increases, the effect of the crystalline polyester A decreases.

As a result, the low temperature fixability deteriorates.

By contrast, if the crystalline polyester increases, the crystalline polyester. A becomes compatible with the component of the non-crystalline resin B other than the component insoluble in chloroform thereof during melt-kneading, so that the high temperature stability extremely deteriorates because the glass transition temperature of the non-crystalline resin B falls.

As a result of an investigation of the present inventors, it has been found that when prescribing only the crystalline polyester A and the non-crystalline resin B, the energy consumption by the fixing device is successful in decreasing in any blending ratio of the crystalline polyester A and the non-crystalline resin B but there is no blending ratio to satisfy the low temperature fixability, the high temperature stability, and the hot offset resistance.

For this reason, the non-crystalline resin C having a softening temperature (T1/2) 25° C. or more lower than that of the non-crystalline resin B is used in combination.

By reducing the blending ratio of the crystalline polyester A to reduce the falling of the glass transition temperature due to the compatibilization of the crystalline polyester A and the component of the non-crystalline resin B other than the component insoluble in chloroform thereof and assisting the low temperature fixability of the crystalline polyester A by the non-crystalline resin C, the hot offset resistance is found not to be inhibited by the non-crystalline resin B.

However, usage of the non-crystalline resin C in addition to the crystalline polyester A and the non-crystalline resin B is not successful in obtaining a satisfactory high temperature stability.

Even if the compatibilization of the crystalline polyester A and the component of the non-crystalline resin B other than the component insoluble in chloroform thereof is successfully reduced to reduce the drop of the glass transition temperature of the toner binder but the crystalline polyester A is present as the dispersion diameter thereof is still large, the toner is easily pulverized at the interface of the crystalline polyester A and the non-crystalline resins in the pulverization process so that the crystalline polyester A tends to be exposed to the surface of the toner particle.

The crystalline polyester A is a sharp melt material.

When the crystalline polyester A is present inside the toner particle, it exhibits excellent high temperature stability as described above.

When the crystalline polyester A is present on the surface of the toner particle, the crystal slightly breaks at the glass transition temperature of the toner binder or lower.

As a consequence, the crystalline polyester A works as a binder between the toner particles, which leads to the deterioration of the high temperature stability of the toner.

This phenomenon is significant in a case of a crystalline polyester resin having a low crystallinity.

In addition, if the non-crystalline resin C is added to reduce the compatibilization of the crystalline polyester A and the component of the non-crystalline resin B other than the component insoluble in chloroform thereof, the toner material containing the non-crystalline resin C does not receive a shearing force easily during melt-kneading because the viscosity of the non-crystalline resin C is low.

Consequently, the dispersion diameter of the crystalline polyester resin A tends to be large.

The crystalline polyester resin A has a relatively low electric resistance.

In addition, the other toner materials such as a coloring agent, a releasing agent, and a resistance control agent do not enter into the domain of the crystalline polyester resin A and thus are present in the non-crystalline resin B and the non-crystalline resin C in a relatively high concentration.

As the dispersion diameter of the crystalline polyester resin A increases, these are not present evenly in the toner particle, which makes it difficult to control the toner properties such as electric resistance.

Moreover, by using the complex resin D which has a condensation polymerization resin unit and an addition polymerization resin unit and is harder than the non-crystalline resin C, a suitable shearing force is applied during melt-kneading, thereby improving the dispersability of the crystalline polyester A.

The crystalline polyester A is present in the toner particle in fine dispersion state while maintaining the crystallinity.

As a result, the non-uniformity in the toner particle is prevented, which facilitates the control of the toner particles such as electric resistance.

Moreover, the complex resin D is hard and tends to be exposed to the surface of the interface in the pulverization process, which decreases the probability of the non-crystalline resin C having a low softening point being exposed to the surface of the toner particle to improve the high temperature stability.

The complex resin D improves the hardness of the surface of the toner particle, thereby preventing the toner deterioration caused by physical stress.

In a case of using external additives such as a charging property imparting agent and, a fluidity improver, the external additives is prevented from being buried in the toner particle. Moreover, the toner properties such as the chargeability are not easily affected by the stress so that the quality images are produced for an extended period of time.

In the toner binder for use in the present disclosure, the crystalline polyester resin A, the non-crystalline resin B, the non-crystalline resin C, and the complex resin D compensate each other to strike a balance between the low temperature fixability, the high temperature stability, and the hot offset resistance.

The toner has the main peak in a range of from 1,000 to 10,000 of a molecular weight distribution of the toner by GPC obtained from the component soluble in tetrahydrofuran with a half width value of the molecular weight distribution of 15,000 or less.

If the connection of the molecules of the component insoluble in chloroform, which is contained in the non-crystalline resin B is short and the molecular weight distribution of the entire toner binder is broad in particular, the low temperature fixability deteriorates due to the non-crystalline resin C having a low softening temperature.

Each resin forming the toner binder is described next.

### Crystalline Polyester A

Any known crystalline polyester can be used as the crystalline polyester resin A for use in the present disclosure.

As the acid component thereof, a straight chain unsaturated aliphatic dicarboxylic acid is advantageous over an aromatic dicarboxylic acid in terms of forming a crystalline structure and helps the crystalline polyester resin to exhibit the feature thereof.

The polyester resin A is manufactured by conducting polycondensation reaction of a straight chain unsaturated aliphatic dicarboxylic acid or a polycarboxylic acid formed of reaction derivatives (acid anhydride, a lower alkyl erter having one to four carbon atoms, acid hallide, etc.) of the straight chain unsaturated aliphatic dicarboxylic acid and a polyalcohol component formed of a straight chain aliphatic diol and preferably has an ester bond represented by the following chemical structure 1 in the main molecular chain:

[—OCO—R—COO—(CH₂)ₙ—] Chemical Structure 1

In the Chemical Structure 1, R represents a straight chain unsaturated aliphatic dicarboxylic acid residual group having 2 to 20 carbon atoms and n represents an integer of from 2 to 20.

The presence of the Chemical Structure 1 can be confirmed by a solid C¹³ nuclear magnetic resonance analysis (NMR).

Specific examples of the straight chain unsaturated aliphatic group include, but are not limited to, straight chain unsaturated aliphatic groups deriving from a straight chain unsaturated dicarboxylic acid such as maleic acid, fumaric acid, 1,3-n-propene dicarboxylic acid, and 1,4-n-butene dicarboxylic acid.

In the Chemical Structure 1, (CH₂)ₙ represents a straight chain aliphatic diol residual group. Specific examples of the straight chain aliphatic diol residual groups include, but are not limited to, derivatives from straight chain aliphatic diols such as ethylene glycol, 1,3-propylene glycol, 1,4-butane diol, and 1,6-hexane diol.

In addition to the polycarboxylic acid component, a minor amount of other polycarboxylic acids can be added.

The other polycarboxylic acids include, but are not limited to, (i) unsaturated aliphatic dicarboxylic acid having a branch chain; (ii) saturated ailphatic polycarboxylic acids such as saturated aliphatic dicarboxylic acids and saturated aliphatic tricarboxylic acids; (iii) aromatic polycarboxylic acids such as aromatic dicarboxylic acids and aromatic tricarboxylic acids.

Specific examples thereof include, but are not limited to, dicarboxyli acids, for example, maronic acid, succinic acid, glutamic acid, adipic acid, suberic acid, sebacic acid, citraconic acid, phthalic acid, isophthalic acid, and terephthalic acid; and tri- or higher carboxylic acid such as trimellitic anhydride, 1,2,4-benzene tricarboxylic acid, 1,2,5-benzene tricarboxylic acid, 1,2,4-cyclohexane tricarboxylic acid, 1,2,4-naphtalene tricarboxylic acid, 1,2,5-hexane tricarboxylic acid, 1,3-dicarboxylic-2-methylene carboxy propane, and 1,2,7,8-octane tetracarboxylic acid.

The content of the other polycarboxylic acids is 30 mol % or less and preferably 10 mol % or less based on the total amount of carboxylic acid.

The other polycarboxylic acids are arbitraily added as long as the obtained polyester maintains crystallinity.

In addition to the polyalcohol component, it is suitable to add other polyalcohol components, if desired.

Specific examples thereof include, but are not limited to, aliphatic branch chain dialcohols and cyclic dialcohols and tri- or higher alcohols.

Specific examples thereof include, but are not limited to, 1,4-bis(hydroxymethyl)cyclohexane, polyethylene glycol, adducts of bisphenol A with ethylene oxide, adducts of bisphenol A with propylene oxide, and glycerine.

The content of the other polyalcohols is 30 mol % or less and preferably 10 mol % or less based on the total amount of alcohol.

The other polyalcohol is arbitrarily added as long as the obtained polyester maintains crystallinity.

The molecular weight distribution of the crystalline polyester resin A is preferably sharp in terms of the low temperature fixability.

In the molecular weight distribution diagram with an X axis of log (M: molecular weight) and a Y axis of % by weight, the crystalline polyester resin A has a molecular weight peak in the range of from 3.5% by weight to 4.0% by weight and the half width value of the peak is preferably 1.5 or less.

In addition, the molecular weight of the crystalline polyester resin A is preferably a relatively small In the molecular weight distribution of GPC for the component soluble in o-dichlororbenzene, it is preferable that the weight average molecular weight (Mw) is from 5,500 to 6,500, the number average molecular weight (Mn) is from 1,300 to 1,500, and the ratio (Mw/Mn) of Mw to Mn is from 2 to 5.

GPC (gel permeation chromatography) is conducted as follows:

Stabilize the column in a heat chamber at 40° C., and infuse 50 μl to 200 μl of a tetrahydrofuran (THF) sample solution prepared to have a sample concentration of from 0.05% by weight to 0.6% by weight into the column at this temperature while flowing THF as a solvent at a flowing speed of 1 m per minute.

With regard to the measuring of the molecular weight of the sample (toner), the molecular weight distribution of the sample is calculated by the relation between the logarithmic value of the obtained standard curve and the number of counts from several kinds of a simply-dispersed polystyrene standard sample.

As the polystyrene standard sample for the standard curves, it is suitable to use at least around 10 polystyrene standard samples (manufactured by PRESSURE CHEMICAL CO. or TOSOH CO_, LTD.) having a molecular weight of 6×10², 2.1×10³, 4×10³, 1.75×10⁴, 5.1×10⁴, 1.1×10⁵, 3.9×10⁵, 8.6×10⁵, 2×10 ⁶, or 4.48×10⁶.

A refractive index (RI) detector is used as the detector.

In addition, it is preferable that the crystalline polyester resin A has a low glass transition temperature Tg and a low softening temperature T1/2 unless the high temperature stability of the toner deteriorates.

The glass transition temperature Tg of the crystalline polyester resin A is preferably from 80° C. to 130° C. and more preferably from 80° C. to 125° C.

The softening temperature T1/2 of the crystalline polyester resin A is preferably from 80° C. to 130° C. and more preferably from 80° C. to 125° C.

When the glass transition temperature Tg and the softening temperature T1/2 are above the range specified above, the lowest fixing temperature of the toner becomes high, thereby degrading the low temperature fixability.

The softening temperature T1/2 of the binder resin is measured by the temperature corresponding to a half between the starting point and the completion point of the effusion of the sample when melting and flowing a sample of 1 cm² under the condition of a dice hole diameter of 1 mm, a pressure of 20 kg/cm², and a temperature rising speed of 6° C./minutes using a flow tester (CFT-500, manufactured by SHIMADZU CORPORATION).

The measuring method of the glass transition temperature Tg is deferred.

In addition, whether the polyester resin has crystallinity can be checked by whether a peak is observed in the X-ray diffraction pattern as measured by a powder X-ray diffraction device.

With regard to the crystalline polyester resin A, in the diffraction pattern, at least one peak is observed at 2θ of from 19 to 25° and preferably peaks are observed at 2θ of from 19 to 20°, 21° to 22°, 23° to 25°, and 29° to 31°.

A diffraction peak that is observed at 2θ of from 19° to 25° after the toner is manufactured means that the crystalline polyester resin A maintains the crystallinity.

The crystalline polyester resin A is certain to exhibit the feature of the crystalline polyester resin A.

In the powder X-ray diffraction measuring, RINT1100 (manufactured by RIGAKU CORPORATION) is used under the conditions of a tube bulb: Cu, tube voltage—current: 50 kV-30 mA with a wide angle goniometer.

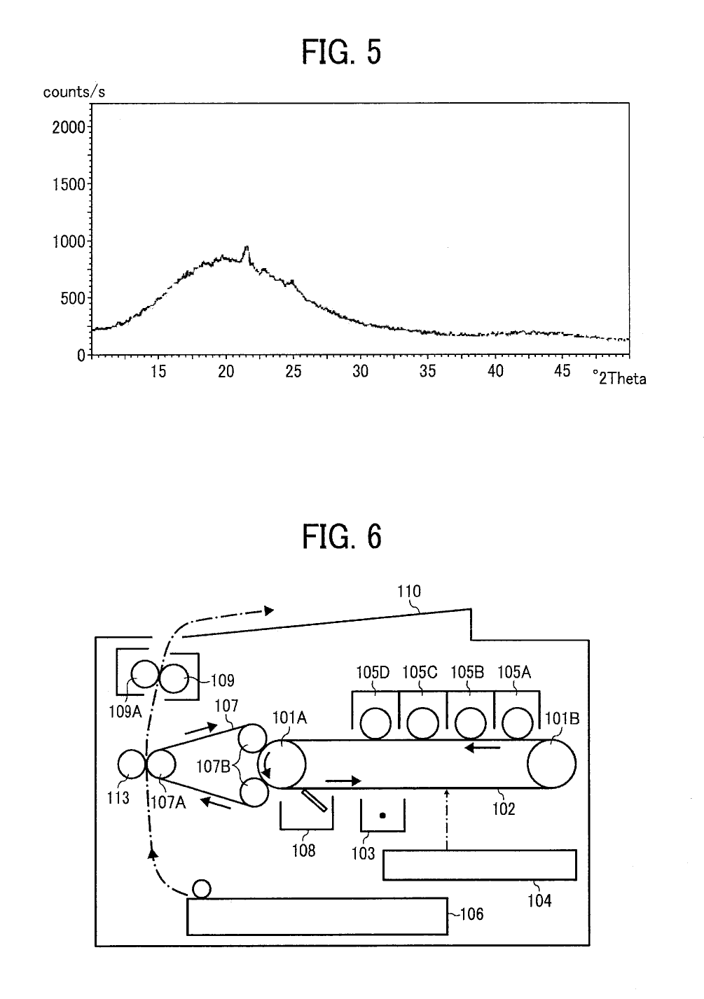

FIG. 4 is a graph illustrating the results of X-ray diffraction of the crystalline polyester resin 6a for use in Examples described later and FIG. 5 is a graph illustrating the results of X-ray diffraction of the toner obtained in Example 35.

Non-Crystalline Resin

The non-crystalline resin of the present disclosure contains the non-crystalline resin B containing a component insoluble in chloroform and the non-crystalline resin C having a softening temperature (T1/2) 25° C. or more lower than that of the non-crystalline resin B.

The non-crystalline resin B improves the offset resistance of the toner and the non-crystalline resin C improves the low temperature fixability.

With regard to the non-crystalline resin B and the non-crystalline resin C, known materials can be used which satisfy the relations about the content of the component insoluble in chloroform and the softening temperatures of the non-crystalline resin B and the non-crystalline resin C.

Specific examples thereof include, but are not limited to, styrene-based resins (styrene or mono- or copolymer containing a styrene substitute) such as polystyrene, polychlorostyrene, poly-α-methylstyrene, copolymers of styrene and chlorostyrene, copolymers of styrene and propylene, copolymers of styrene and butadiene, copolymers of styrene and vinyl chloride, copolymers of styrene and vinyl acetate, copolymers of styrene and maleic acid, copolymers of styrene and acrylic esters (such as copolymers of styrene and methyl acrylate, copolymers of styrene and ethyl acrylate, copolymers of styrene and butyl acrylate, copolymers of styrene and octyl acrylate, and copolymers of styrene and phenyl acrylate), copolymers of styrene and methacrylic esters (such as copolymers of styrene and methyl methacrylate and copolymers of styrene and acrylic esters (such as copolymers of styrene and methyl methacrylate, copolymers of styrene and ethyl methacrylate, copolymers of styrene and butyl methacrylate, and copolymers of styrene and phenyl methacrylate), copolymers of styrene-based resins such as styrene-a-chloro methyl acrylate and copolymers of styrene-acrylonitrile-acrylic ester, epoxy resins, polyester resins, polyethylene resins, polypropylene resins, ionomer resins, polyurethane resins, ketone resins, copolymers of ethylene and ethyl acrylate, xylene resins, polyvinyl butyral resins, petroleum resins, and hydrogenated petroleum resins.

These can be used alone or in combination. Among these, polyester resins are preferable in terms of the low temperature fixability.

In addition, there is no specific limit to the methods of manufacturing these resins. Any of bulk polymerization, solution polymerization, emulsification polymerization, and suspension polymerization can be used.

Typically, the polyester resins are usable which are obtained by condensation polymerization of an alcohol and a carboxylic acid.

Specific examples of such alcohols include, but are not limited to, glycols such as ethylene glycol, diethylene glycol, triethylene glycol, and propylene glycol, 1,4-bis (hydroxymethyl)cyclohexane, etylated bisphenols such as bisphenol A, diol monomers, tri- or higher polyol monomers.

Specific examples of the carboxylic acids include, but are not limited to, two-valent organic acid monomers such as maleic acid, fumaric acid, phthalic acid, succinic acid, and moronic acid; and tri- or higher carboxylic acid monomers such as 1,2,4-benzene tricarboxylic acid, 1,2,5-benzene tricarboxylic acid, 1,2,4-cyclohexane tricarboxylic acid, 1,2,4-naphthalene tricarboxylic acid, 1,2,5-hexane tricarboxylic acid, 1,3-dicarboxyl-2-methylene carboxy propane, and 1,2,7,8-octane tetracarboxylic acid.

The non-crystalline resin B contains a component insoluble in chloroform and improves the hot offset resistance of the toner.

The content of the component insoluble in chloroform is preferably from 5% by weight to 40% by weight in terms of demonstration of the hot offset resistance.

In addition, after the toner is manufactured, if the content of the component insoluble in chloroform in the toner ranges from 2% by weight to 20% by weight, the blend ratio of the resins other than the non-crystalline resin B is secured while maintaining the hot offset resistance.

When the component insoluble in chloroform in the toner is excessively small, the hot offset resistance ascribable to the component insoluble in chloroform is weak. When the component insoluble in chloroform in the toner is excessively large, the ratio of the binder resin contributing to the low temperature fixability is relatively small, thereby degrading the low temperature fixability.

The component insoluble in chloroform is measured as follows:

Weigh about 1.0 g of the toner (or binder resin); Add about 50 g of chloroform thereto; Separate the sufficiently-dissolved solution by a centrifugal; and Filtrate the resultant by using qualitative filter paper of JIS-P3 801 Grades No. 5C at room temperature.

The filtrate is the insoluble component and the content of the component insoluble in chloroform is represented by the ratio of the mass of the toner to the mass of the filtrate on the filter paper in % by weight.

When measuring the component insoluble in chloroform in the toner, solid materials such as pigment remain in the filtrate on the filter paper.

The component insoluble in chloroform is obtained by thermal analysis.

The non-crystalline resin C assists the low temperature fixability ascribable to the crystalline polyester resin A and contributes to improve the low temperature fixability.

The non-crystalline resin C has a softening temperature (T1/2) 25° C. or more and preferably from 35° C. to 50° C. lower than that of the non-crystalline resin B.

The glass transition temperature Tg is preferably 55° C. or higher and more preferably from 60° C. to 80° C. in terms of the high temperature stability.

The non-crystalline resin C preferably has a main peak between 1,000 to 10,000 in the molecular weight distribution of GPC obtained from the component soluble in THF and a half width value of 15,000 or less.

Such a non-crystalline resin C has an extremely excellent low temperature fixability and assists improving the low temperature fixability sufficiently even when the content of the crystalline polyester resin is reduced.

In addition, paradoxically, even when the non-crystalline resin C having the molecular weight distribution described above is used, the ratio of the non-crystalline resin C increases among the binder resins constituting the toner if the toner has a main peak between 1,000 to 10,000 in the molecular weight distribution of the toner and the half width value is 15,000 or less.

Complex Resin

The complex resin D is a resin (also referred to as hybrid resin) in which a condensation polymerization resin unit and an addition polymerization resin unit are chemically bonded.

The complex resin D improves the dispersability of the crystalline polyester A and other toner materials while preventing non-uniformity in the toner particle.

The complex resin D is obtained by conducting condensation polymerization reaction and addition polymerization reaction of a mixture containing a condensation polymerization monomer and an addition polymerization monomer serving as a raw material simultaneously or sequentially in this order or vice-versa in a reaction container.

Specific example of the condensation polymerization monomers for the complex resin D include, but are not limited to, a polyalcohol and a polycarboxylic acid that form a polyester resin unit, a polycarboxylic acid and an amine that form a polyamide resin unit or a polyester-polyamide resin unit, and an amino acid.

A complex resin that contains a condensation polymerization resin unit of a polyester resin and an addition polymerization unit of a vinyl resin is preferable in terms of good demonstration of the feature of the complex resin D.

Diols and tri- or higher alcohols are usable as the polyols.

Specific examples of the diols include, but are not limited to, 1,2-propane diol, 1,3-propane diol, ethylene glycol, propylene glycol, 1,3-butane diol, 1,4-butane diol, 2,3-butane diol, diethylene glycol, triethylene glycol, 1,5-pentane diol, 1,6-hexane diol, neopentyl glycol, 2-ethyl-1,3-hexane diol, hydrogenated bisphenol A, and diols obtained by polymerizing bisphenol A with a cyclic ether such as ethylene oxide and propylene oxide.

Specific examples of the tri- or higher alcohols include, but are not limited to, sorbitol, 1,2,3,6-hexane tetrol, 1,4-sorbitan, pentaerythritol, dipentaerythritol, tripentaerythritol, 1,2,4-butane triol, 1,2,5-pentatriol, glycerol, 2-methyl propane triol, 2-methyl-1,2,4-butane triol, trimethylol ethane, trimethylol propane, and 1,3,5-trihydroxy benzene.

Among these, alcohol components having a bisphenol A skeleton such as hydrogenated bisphenol A or diols obtained by polymerizing hydrogenated bisphenol A with a cyclic ether such as ethylene oxide and propylene oxide are preferable because they particularly improve the high temperature stability and the mechanical strength of the resin.

Specific examples of the polycarboxylic acids include, but are not limited to, dicarboxylic acids and tri- or higher carboxylic acids.

Specific examples of the dicarboxylic acids include, but are not limited to, benzene dicarboxylic acid and anhydrides thereof such as phthalic acid, terephthalic acid, and isophthalic acid, alkyl dicarboxylic acids such as succinic acid, adipic acid, sebacic acid, and azelaic acid and anhydrides thereof, unsaturated dibasic acid such as maleic acid, citraconic acid, itaconic acid, alkenyl succinic acid, fumaric acid, and mesaconic acid and anhydriedes thereof, and unsaturated dibasic acid anhydrides such as maleic anhydrides, citraconic anhydrides, itaconic anhydrides, alkenyl succinic acid anhydrides.

Specific examples of the tri- or higher carboxylic acids include, but are not limited to, trimellitic acid, pyromellitic acid, 1,2,4-benzene tricarboxylic acid, 1,2,5-benzene tricarboxylic acid, 2,5,7-naphthalene tricarboxylic acid, 1,2,4-naphthalene tricarboxylic acid, 1,2,4-butane tricarboxylic acid, 1,2,5-hexane tricarboxylic acid, 1,3-dicarboxy-2-methyl-2-methylene carboxypropane, tetrakis(methylene carboxy)methane, 1,2,7,8-octane tetracarboxylic acid, EnPol trimer acid, anhydrides thereof, partially lower alkyl esters thereof.

Among these, aromatic polycarboxylic acid compounds such as phthalic acid, isophthalic acid, terephthalic acid, and trimellitic acid are preferably used because they particularly improve the high temperature stability and the mechanical strength of the resin.

Specific examples of the amine components or amino acid components include, but are not limited to, diamines (B1), polyamines (B2) having three or more amino groups, amino alcohols (B3), amino mercaptans (B4), amino acids (B5), and blocked amines (B6) in which the amino group of the amines (B1-B5) mentioned above is blocked.

Specific examples of the diamines (B1) include, but are not limited to, aromatic diamines (e.g., phenylene diamine, diethyltoluene diamine, and 4,4′-diaminodiphenyl methane); alicyclic diamines (e.g., 4,4′-diamino-3,3′-dimethyldicyclohexyl methane, diaminocyclohexane and isophoron diamine); aliphatic diamines e.g., ethylene diamine, tetramethylene diamine, and hexamethylene diamine); etc.

Specific examples of the polyamines (B2) having three or more amino groups include, but are not limited to, diethylene triamine, and triethylene tetramine.

Specific examples of the amino alcohols (B3) include, but are not limited to, ethanol amine and hydroxyethyl aniline

Specific examples of the amino mercaptan (B4) include, but are not limited to, aminoethyl mercaptan and aminopropyl mercaptan.

Specific examples of the amino acids (B5) include, but are not limited to, amino propionic acid, amino caproic acid, and ε-caprolactum.

Specific examples of the blocked amines (B6) in which the amines (B1-B5) mentioned above are blocked include, but are not limited to, ketimine compounds which are prepared by reacting one of the amines (B1) to (B5) mentioned above with a ketone such as acetone, methyl ethyl ketone and methyl isobutyl ketone; and oxazoline compounds.

The molar ratio of the condensation polymerization monomer components in the complex resin D is preferably from 5 mol % to 40 mol % and more preferably from 10 mol % to 25 mol %.

When the molar ratio is too small, the dispersability with the polyester resin tends to deteriorate.

When the molar ratio is too large, the dispersability of the releasing agent tends to deteriorate.

When conducting the condensation polymerization reaction, it is suitable to use an esterification catalyst.

There is no specific limit to the addition polymerization monomers in the complex esin D.

A specific examples thereof is a vinyl monomer.

Specific examples of the vinyl monomers include, but are not limited to, styrene-based vinyl monomers such as styrene, o-methyl styrene, m-methyl styrene, p-methyl styrene, p-phenyl styrene, p-ethyl styrene, 2,4-dimethyl styrene, p-n-amyl styrene, -tert-butyl styrene, p-n-hexyl styrene, p-n-4-dichloro styrene, m-nitrostyrene, o-nitrostyrene, and p-nitro styrene;

acrylic-based vinyl monomers such as acrylic acid, methyl acrylate, ethyl acrylate, propyl acrylate, n-butyl acrylate, isobutyl acrylate, and n-octyl acrylate; methacrylic-based vinyl monomers such as methacrylic acid, methyl methacrylate, ethyl methacrylate, propyl methacrylate, n-butyl methacrylate, isobutyl methacrylate, n-octyl methacrylate, n-dodecyl methacrylate, 2-ethylhexyl methacrylate, stearyl methacrylate, phenyl methacrylate, dimethylaminoethyl methacrylate, and diethylaminoethyl methacrylate; and other monomers that form vinyl monomers or copolymers.

Specific examples of the other monomers that form vinyl monomers or copolymers include, but are not limited to, monoolefins such as ethylene, propylene, butylene, and isobutylene; polyens such as butadien and isoprene; halogenated vinyl such as vinyl chloride, vinylidene chloride, vinyl bromide, and vinyl fluoride; vinyl esters such as vinyl acetate, vinyl propionate, and vinyl benzoate; vinyl ethers such as vinyl methyl ether, vinyl ethyl ether, and vinyl isobutyl ether: vinyl ketones such as vinyl methyl ketone, vinyl hexyl ketone, methyl isopropenyl ketone; N-vinyl compounds such as N-vinyl pyrrol, N-vinyl caraozole, N-vinyl indol, and N-vinyl pyrrolidone; vinyl naphthaline; derivatives of acrylic acid or methacrylic acid such as acrylonitrile, methacrylonitrile, and acrylic amides; unsaturated dibasic acids such as maleic acid, citraconic acid, itaconic acid, alkenyl succinic acid, fumaric acid, and mesaconic acid; unsaturated dibasic acid anhydrides such as maleic anhydrides, citraconic anhydrides, itaconic anhydrides, alkenyl succinic acid anhydrides; monoesters of unsaturated dibasic acid such as monomethyl maleate, monoethyl maleate, monobutyl maleate, monomethyl citroconate, monoethyl citraconate, monobutyl citraconate, monomerthyl itocaonate, monomerthyl alkenyl succinate, monomerthyl fumarate, and monomethyl mesacoate; unsaturated dibasic esters such as dimethyl maleate and dimethyl fumarate; α, β-unasturated acids such as crotonic acid and cinnamic acid; α, β-unasturated anhydrides such as crotonic anhydrides and cinnmic anhydrides; anhydrides of the α, β-unasturated acids and a lower aliphatic acids, alkenyl maroic acid, alkenyl glutalic acid, alkenyl adipic acid, anhydrides thereof or monoesters thereof having a carboxylic group; acrylic or methacrylic acid hydroxy alkyl esters such as 2-hydroxy ethyl acrylate, 2-hydroxy ethyl methacrylate, 2-hydroxy propyl methacrylate; and monomers having a hydroxy group such as 4-(1-hydroxy-1-methylbutyl) styrene and 4-(1-hydroxy-1-methylhexyl) styrene.

Among these, styrene, acrylic acid, n-butyl acrylate, 2-ethylhexyl acrylate, methacrylic acid, n-butyl methacrylate, and 2-ethylhexyl methacrylate.

A combination of at least styrene and acrylic acid is particularly preferable because the dispersability of the releasing agent is extremely good.

Furthermore, it is suitable to add a cross-linking agent of an addition polymerization monomer.

Specific examples thereof include, but are not limited to, the following:

Specific examples of the aromatic divinyl compounds include, but are not limited to, divinyl benzene and divinyl naphthalene.

Specific examples of the diacrylate compounds linked by an alkyl chain include, but are not limited to, ethylene glycol diacrylate, 1,3-butylene glycol diacrylate, 1,4-butane diol diacrylate, 1,5-pentane diol diacrylate, 1,6-hexane diol diacrylate, neopentyl glycol diacrylate, and compounds thereof in which acrylate is replaced with methacrylate.

Specific examples of the diacrylate compounds linked by an alkyl chain including an ether bond include, but are not limited to, diethylene glycol diacrylate, triethylene glycol diacrylate, tetraethylene glycol diacrylate, polyethylene glycol #400 diacrylate, polyethylene glycol #600 diacrylate, dipropylene glycol diacrylate, and compounds thereof in which acrylate is replaced with methacrylate.

Other specific examples include, but are not limited to, diacylate compounds and dimethacrylate compounds linked by a chain of an aromatic group or an ether bond.

A specific example of the polyester type diacrylate is a product named MANDA (manufactured by NIPPON KAYAKU Co., Ltd.)

Specific examples of multi-functional cross-linking agents include, but are not limited to, pentaerythritol triacrylate, trimethylol ethane triacrylate, trimethylol propane triacrylate, tetramethylol methane tetra acrylate, oligo ester acrylate, compounds thereof in which acrylate is replaced with methacrylate, triaryl cyanulate, and triaryl trimellitate.

The content of the cross-linking agent is preferably from 0.01 parts by weight to 10 parts by weight and more preferably 0.03 parts by weight to 5 parts by weight based on 100 parts by weight of the addition polymerization monomer to be used.

There is no specific limit to the polymerization initiators for use in polymerizing the addition polymerization monomers.

Specific examples thereof include, but are not limited to, azo-based polymerization initiators such as 2,2′-azobis isobutylonitrile, 2,2′-azobis (4-methoxy-2,4-dimethyl valeronitrile), and 2,2′-azobis (2,4-dimethyl valeronitrile); and peroxide-based polymerization initiators such as methylethyl ketone peroxide, avetyl avetone peroxide, 2,2-bis(tert-butyl peroxy) butane, tert-butylhydroperoxide, benzoyl peroxide, and n-butyl-4,4′-di-(tert-butylperoxy) valerate.

These can be also used in combination to control the molecular weight and the molecular weight distribution of the resin.

The addition amount of the polymerization initiator is preferably from 0.01 parts by weight to 15 parts by weight and more preferably from 0.1 parts by weight to 10 parts by weight.

To chemically bond the condensation polymerization resin unit and the addition polymerization resin unit, for example, a monomer reactive in both condensation polymerization and addition polymerization is used.

Specific examples of the monomers reactive in both condensation polymerization and addition polymerization include, but are not limited to, unsaturated carboxylic acid such as acrylic acid and methacrylic acid; unsaturated dicarboxylic acids such as fumaric acid, maleic acid, citraconic acid, and itaconic acid and anhydrides thereof; and vinyl monomers having a hydroxy group.

The content of the monomers reactive in both condensation polymerization and addition polymerization is preferably from 1 part by weight to 25 parts by weight and more preferably 2 parts by weight to 20 parts by weight based on 100 parts by weight of the addition polymerization monomer to be used.

With regard to the complex resin D, in the same reaction container, it is possible to conduct and complete the condensation polymerization reaction and the addition polymerization reaction simultaneously, or independently by setting the reaction temperature and the time.

For example, it is possible to conduct condensation polymerization by completing radical polymerization reaction initially by preliminary mixing a mixture of condensation polymerization monomers in a reaction container with a mixture formed of an addition polymerization monomer and a polymerization initiator by dripping followed by raising the reaction temperature.

By proceeding two kinds of reaction conducted independently in the same reaction container, it is possible to disperse and bond the two kinds of resin units suitably.

The softening temperature T1/2 of the complex resin D is preferably from 90° C. to 130° C. and more preferably from 100° C. to 120° C.

When the softening temperature T1/2 is too low, the high temperature stability and the offset resistance tend to deteriorate and when it is too high, the low temperature fixability easily deteriorates.

The glass transition temperature of the complex resin D is preferably from 45° C. to 80° C., more preferably from 50° C. to 70° C., and furthermore preferably from 53° C. to 65° C.

The acid value of the complex resin D is preferably from 5 mgKOH/g to 80 mgKOH/g and more preferably from 15 mgKOH/g to 40 mgKOH/g.

The toner binder of the present disclosure is a combined material of the crystalline polyester resin A, the non-crystalline resin B, the non-crystalline resin C, and the complex resin D.

The toner binder containing these binders strikes an excellent balance to have excellent low temperature fixability, high temperature stability, and hot offset resistance when increasing the ratio of the non-crystalline resin B because the features of each resin exhibits suitably without the side effect caused by an excessive amount of crystalline polyester resin or the insoluble portion in THF or an adverse impact on the lowest fixing temperature.

For this reason, the content of the crystalline polyester A in the toner binder is preferably from 1% by weight to 15% by weight and more preferably from 10% by weight to 40% by weight.

The content of the non-crystalline resin B is preferably from 10% by weight to 40% by weight.

The content of the non-crystalline resin C is preferably from 50% by weight to 90% by weight.

The content of the non-crystalline resin D is preferably from 3% by weight to 20% by weight.

The toner of the present disclosure optionally contains a coloring agent, a releasing agent, a charge control agent, and an aliphatic acid amide compound.

Specific examples of the coloring agent include, but are not limited to, known pigments and dyes such as carbon black, lamp black, iron black, aniline blue, phthalocyanine blue, phthalocyanine green, Hanza Yellow G, Rohdamine 6C lake, Calco Oil blue, chrome yellow, quinacridone, benzidine yellow, rose bengal, and triaryl methane-based dyes.

These can be used alone or in combination and also as black toner or full color toner.

In particular, carbon black has good black coloring ability. However, at the same time, carbon black is good electroconductive material, thereby lowering the electric resistance or inviting a problem about the transfer performance in the transfer process if the amount is excessively large or it exists in the toner particle in an agglomerated state.

In particular, in a case in which carbon black is used in combination with the crystalline polyester resin A, the carbon black particles do not enter into the domain of the crystalline polyester resin.

If the, crystalline polyester resin exists in the toner while having a large dispersion diameter, the carbon black particles are present accounting for a relatively large ratio in resins other than the crystalline polyester resin.

Agglomerated carbon black particles are easily enclosed in the toner, so that the electric resistance thereof excessively falls.

In the present disclosure, black carbon is used in combination with the complex resin D so that the dispersion of carbon black is good, thereby reducing the problem described above.

If carbon black is contained, the viscosity of the melted toner increases during fixing the toner on a recording medium.

If the non-crystalline resin C is blended in a large amount, hot offset caused by the degradation of the viscosity can be reduced.

The content of the coloring agent is from 1% by weight to 30% by weight and preferably from 3% by weight to 20% by weight based on the toner resin component.

Known releasing agents are usable.

Specific examples of the releasing agents include, but are not limited to, polyolefin waxes having low molecular weights such as polyethylene waxes having low molecular weights and polypropylene waxes having low molecular weights; synthetic hydrocarbon waxes such as Fisher-Tropsch wax; natural waxes such as carnauba wax, Candelilla wax, rice wax, montan wax, petroleum waxes such as paraffin waxes, microcrystalline wax; higher aliphatic acid such as stearic acid, palmitic acid, and milistic acid, and metal salts thereof; and modified waxes such as higher aliphatic acid amides and synthetic ester waxes.

Among these releasing agents, carnauba wax and its modified wax, polyethylene wax, synthetic ester wax are preferably used. Particularly, carnauba wax is appropriately fine-dispersed in a polyester resin and a polyol resin, which is extremely preferable because it facilitates making toner having excellent hot offset resistance and transferability and durability.

If used in combination with an aliphatic amide compound, the releasing agent has a strong ability to stay on the surface of the fixed image, thereby improving the smear-resistance.

These releasing agents can be used alone or in combination.

The content of the releasing agent is preferably from 2% by weight to 15% by weight based on the toner.

When the content of the releasing agent is too low, the hot offset resistance tends to be insufficient.

When the content is too high, the transferability and the durability tend to deteriorate. The melting point of the releasing agent is preferably from 70° C. to 150° C.

When the melting point is too low, the high temperature stability of the toner tends to deteriorate.

When the melting point is too high, the releasability tends to be not suffice.

Specific examples of the charge control agents include, but are not limited to, modified agents by nigrosine or an aliphatic acid metal salt, onium salts such as phosphonium salts and lake pigments thereof; triphenyl methane dyes and lake pigments thereof, metal salts of higher aliphatic acids; diorgano tin oxides such as dibutyl tin oxide, dioctyl tin oxide, and dicyclohexyl tin oxide; diorgano tin borates such as dibutyl tin borates, dioctyl tin borates, dicyclohexyl tin borates; organic metal complexes, chleate compounds, monoazo metal complexes, acetyl acetone metal salts, aromatic hydroxy carboxylic acids, aromatic dicarboxylic acid-based metal salts, quaternary ammonium salts, and salicylic acid metal compounds.

In addition, other specific examples include aromatic hydroxycarboxylic acids, aromatic mono and poly carboxylic acids and salts thereof, anhydrides thereof, esters thereof, phenolic derivatives (such as bisphenols) thereof.

Any of such polarity control agents can be used alone or in combination.

The content of the polarity control agents is from 0.1 parts by weight to 10 parts by weight and preferably from 1 part to 5 parts by weight.

Among these charge control agents, a combinational use with salicylic acid metal compounds is preferable to improve the hot offset resistance.

In particular, tri- or higher functional complexes having a structure of 6 coordinations reacts with reactive portions of a resin and wax and forms a light cross-linking structure, thereby having an impact on the hot offset resistance.

In addition, by a combinational use of the complex resin D, the dispersability ameliorates, thereby exhibiting the charge control power more suitably.

Specific examples of the tri- or higher functional metals include, but are not limited to, Al, Fe, Cr, and Zr.

The compound represented by the following chemical structure 2 can be used as a salicylic acid compound. When M is zinc, one specific example is BONTRON E-84, manufactured by ORIENT CHEMICAL INDUSTRIES CO., LTD.

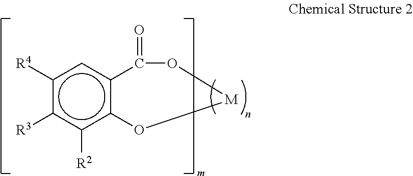

In the Chemical Structure 2, R², R³, and R⁴ independently represent hydrogen atoms, straight chain or branch chain alkyl groups having 2 to 10 carbon atoms or alkenyl groups having 2 to 10 carbon atoms, M represents chromium, zinc, calcium, zirconium, or aluminum, m represents an integer of 2 or greater, and n represents an integer of 1 or greater.

The toner preferably has an aliphatic acid amide compound.

If an aliphatic acid amide compound is blended with the crystalline polyester resin in pulverized toner manufactured by a method including a melt-kneading process, re-crystallization of the crystalline polyester resin melted during kneading is promoted in the mixed and melted material when cooled down.

This results in less compatilization with the resin so that the fall of the glass transition temperature is prevented, thereby improving the high temperature stability.

When used in combination with the releasing agent, the releasing agent stays on the surface of the fixed image, thereby improving the abrasion resistance (smearing resistance).

The content of the aliphatic amide compound in the toner is preferably from 0.5% by weight to 10% by weight.

The compound represented by the following chemical structure 3 and alkylene his aliphatic acid amides can be used as the aliphatic amide compound.

Alkylene bis aliphatic acid amide is preferable.

R1-CO—NR²R³ Chemical Structure 3

In the chemical structure 3, R¹ represents an aliphatic hydrocarbon group having 10 to 30 carbon atoms, R² and R³ independently represent hydrogen atoms, alkyl groups having 1 to 10 carbon atoms, aryl groups having 6 to 10 carbon atoms, or aralkyl groups having 7 to 10 carbon atoms.

The alkyl groups, the aryl groups, the aralkyl groups of R² and R³ can be replaced with inert substituents such as fluorine atoms, chlorine atoms, cyano groups, alkoxy groups, or alkylthio groups.

Non-substituted groups thereof are preferable.

Specific examples include, but are not limited to, stearic acid amide, stearic acid methylamide, stearic acid diethyl amide, stearic acid benzyl amide, stearic acid phenyl amide, behenic acid amide, behenic acid dimethyl amide, myristic acid amide, and palmitic acid amide.

The alkylene bis aliphatic acid amide is the compound represented by the following Chemical Structure 4.

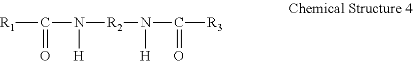

In the Chemical Structure 4, R¹ and R³ independently represent alkyl groups or allkenyl groups having 5 to 21 carbon atoms and R² represents an alkylene group having 1 to carbon atoms.

Specific examples of the alkylenebis saturated aliphatic acid amide represented by the Chemical Structure 4 illustrated above include, but are not limited to, methylenebis stearic acid amide, ethylenebis stearic acid amide, methylenebis spalmitic acid amide, ethylenebis palmitic acid amide, methylenebis behenic acid amide, ethylenebis behenic acid amide, hexamethylenebis stearic acid amide, hexaethylenebis palmitic acid amide, and hexamethylenebis behenic acid amide.

Among these, ethylenebis stearic acid amide is most preferable.

The aliphatic acid amide compounds exhibits the feature as the releasing agent on the surface of the fixing member when the softening temperature T1/2 is lower than the temperature at the surface of the fixing member during fixing.

Specific examples of the alkylene bis aliphatic acid amide compounds in addition to those specified above include, but are not limited to, saturated or mono- or di unsaturated aliphatic alkylene bis aliphatic acid amide compounds such as propylene bis stearic acid amide, butylene bis stearic acid amide, methylene bis oleic acid amide, ethylene bis oleic acid amide, propylene bis oleic acid amide, butylene bis oleic acid amide, methylene bis lauric acid amide, ethylene bis lauric acid amide, propylene bis lauric acid amide, butylene bis lauric acid amide, methylene bis myristic acid amide, ethylene bis myristic acid amide, propylene his myristic acid amide, butylene bis myristic acid amide, propylene bis palmitic acid amide, butylene his almitic acid amide, methylene bis palmitoleic acid amide, ethylene bis palmitoleic acid amide, propylene his palmitoleic acid amide, butylene bis palmitoleic acid amide, methylene bis arachidic acid amide, ethylene bis arachidic acid amide, propylene bis arachidic acidamide, butylene bis arachidic acid amide, methylene bis eicosenoic acid amide, ethylene bis eicosenoic acid amide, propylene bis eicosenoic acidamide, butylene bis eicosenoic acid amide, methylene bis behenic acid amide, ethylene bis behenic acid amide, propylene bis behenic acidamide, butylene bis behenic acid amide, methylene his erucic acid amide, ethylene bis erucic acid amide, propylene bis erucic acidamide, and butylene bis erucic acid amide.

The toner for use in electrophotography of the present disclosure preferably has an endothermic peak in a range of from 90° C. to 130° C. ascribable to the crystalline polyester resin A as measured by DSC for the endothermic peak.

If the endothermic peak ascribable to the crystalline polyester resin A is present in the range of from 90° C. to 130° C., the crystalline polyester resin does not melt at room temperature and the toner is melted and fixed on a recording medium in a relatively low fixing temperature range, thereby improving the high temperature stability and the low temperature fixability.

The endothermic amount of the endothermic peak is preferably from 1 J/g to 15 J/g.

When the endothermic amount is too small, the ability of the crystalline polyester resin is not exhibited sufficiently because the amount of the crystalline polyester resin effectively working in the toner particle is too small.

When the endothermic amount is too large, the absolute amount of the compatibilization with the non-crystalline polyester resin tends to increase because the amount of the crystalline polyester resin working in the toner particle is excessively large.

The glass transition temperature of the toner lowers, which leads to deterioration of the high temperature stability.

The DSC measurement (endothermic peak and glass transition temperature Tg) in the present disclosure is conducted by a differential scanning calorimeter (DSC-60, manufactured by SHIMADZU CORPORATION) in a temperature range of from 20° C. to 150° C. at 10° C. per minute.

The endothermic peak ascribable to the crystalline polyester in the present disclosure is present around the melting point of the crystalline polyester of from 80° C. to 130° C., so that the endothermic amount is obtained by the area enclosed by the base line and the endothermic curve.

In general, in the endothermic amount as measured by DSC, the temperature is raised twice for measuring.

The endothermic peak and the glass transition temperature in the present disclosure are guided by using the endothermic curve obtained from the first temperature rising.

When the endothermic peak ascribable to the crystalline polyester A overlaps the endothermic peak of the wax, the endothermic amount of the wax is subtracted from the overlapped endothermic amount.

The endothermic amount of the wax is calculated from the endothermic amount of the simple wax and the content of the wax contained in the toner.

There is no specific limit to the particle diameter of the toner of the present disclosure. The volume average particle diameter thereof is preferably from 4 μm to 10 μm to produce quality images with excellent fine line reproducibility.

A particle diameter that is too small tends to degrade the cleanability in the development process and the transfer efficiency in the transfer process, which leads to deterioration of the image quality.

When the particle diameter is too large, the fine line reproducibility tends to deteriorate.

The volume average particle diameter of the toner is measurable by various methods. In the present disclosure, COULTER COUNTER TA II (manufactured by COULTER ELECTRONICS, INC.) is used.

The toner for use in the present disclosure is preferably pulverized toner manufactured by a so-called pulverization method including at least a melt-kneading process in the manufacturing.

In the pulverization method, toner materials that contains the crystalline polyester resin A, the non-crystalline resin B, the non-crystalline resin C, and the complex resin D, the coloring agent, and the releasing agent is dry-mixed and melt-kneaded by an melt-kneading machine followed by pulverization to obtain pulverized toner.

In the melt-kneading, the toner material is mixed first and placed in a melt-kneading machine for melt-kneading.

Single-screw or twin-screw continuous kneading machines or batch type kneading machines by a roll mill can be used as the melt-kneading machine. Specific examples thereof include, but are not limited to, KTK type twin-screw extruders (manufactured by KOBE STEEL., LTD.), TEM type extruders (manufactured by TOSHIBA MACHINE CO., LTD.), twin-screw extruders (manufactured by KCK), PCM type twin-screw extruders (manufactured by IKEGAI CORP.), and Ko-kneaders (manufactured by Buss).

It is preferable that this melt-kneading is conducted under suitable conditions in order to avoid severing the molecular chain of the binder resins.

Specifically, the temperature in the melt-kneading operation is determined referring to the softening point of the binder resin.

When the temperature is too high in comparison with the softening point, the molecular chain tends to be severely severed.

When the temperature is too high in comparison with the softening point, dispersion tends not to proceed smoothly.

In the pulverization process, the mixture obtained in the melt-kneading is pulverized. In the pulverization process, it is preferable to coarsely pulverize the melt-kneaded materials first followed by fine pulverization.

In this process, melt-kneaded mixtures are pulverized by collision with a collision board in a jet stream, collision between particles in a jet stream, and pulverization at narrow gaps between a stator and a rotor that is mechanically rotating, etc.

The classification process adjusts the pulverized material obtained in the pulverization process by classification to have a predetermined particle diameter.

The classification can be performed by removing particulate portions using a cyclone, a decanter, a centrifugal, etc.

After the pulverization and classification, the pulverized material is classified into an air stream by centrifugal, etc. to manufacture toner particles having a predetermined particle diameter.

The toner for use in the present disclosure is pulverized toner manufactured through the melt-kneading process in the manufacturing.

In the cooling process after the melt-kneading of the raw materials, if the thickness of the melt-kneaded materials is 2.5 mm or greater, the cooling speed thereof decreases and the period of re-crystallization of the crystalline polyester resin A melted in the melt-kneaded materials is prolonged.

As a result, the re-crystallization is promoted, thereby improving the feature of the crystalline polyester resin A.

To promote re-crystallization, it is suitable to blend an aliphatic acid amide as described above but it is also possible to adjust the manufacturing process in such a manner.

There is no specific limit to the thickness of the melt-kneaded material.

When the thickness is too thick, the efficiency tends to drop extremely in the pulverization process.

For this reason, it is preferable to set the thickness to be 8 mm or less.

Furthermore, inorganic particulates such as hydrophobic silica fine powder may be added to the thus-manufactured mother toner particles to improve the fluidity, the preservability, the developability, and the transferability.

Although the additive is mixed by a typical powder mixer, a mixer having a jacket, etc. is preferable to adjust the internal temperature.

To change the history of the burden applied to the external additive, for example, adding the external additive in the midstream or little by little during mixing is suitable.

It is also suitable to change the number of rotation, rolling speed, time, temperature, etc. of the mixer appropriately.

Moreover, heavy load followed by relatively light load or vice versa is applicable.

Specific examples of the mixers for use in the external additive mixing process include, but are not limited to, V-type mixers, Rocking mixers, Lodige mixers, Nautor mixers, and Henschel mixers.

After the mixing process, it is possible to remove coarse particles and agglomerated particles by a screen having 250 meshes or more.

The toner for use in the present disclosure is used as a development agent.

There is no specific limit to the development agent.

The toner can be used as a single component development agent containing only the toner or a two component development agent containing the toner and toner carrier.

In a case in which the development agent is used in a fast printer, etc. to meet the information processing speed of late, the two component development agent is preferable in terms of the working life length.

In the present disclosure, known methods are applicable to the process of forming a latent electrostatic image on an image bearing member, the process of developing the latent electrostatic image with the development agent containing the toner for electrostatic image development to form a toner image, and the process of transferring the toner image onto a transfer medium.

FIG. 6 is a diagram illustrating an example of the development device for electrophotography for use in the present disclosure.

In FIG. 6, the reference numerals 101A represents a driving roller, 101B represent a driven roller, 102 represents an image bearing member belt, 103 represents a charger, 104 represents a laser-writing unit, 105A, 105B, 105C, and 105D represent development units that accommodate yellow, magenta, cyan, and black toner, respectively, 106 represents a sheet feeding cassette, 107 represents an intermediate transfer belt, 107A represents a driving shaft roller to drive the intermediate transfer belt 107, 107B represents a driven shaft roller to support the intermediate transfer belt 107, 108 represents a cleaner, 109 represents a fixing roller, 109A represents a pressure roller, 110 represents a discharging tray, and 113 represents a sheet transfer roller.

In this color image forming apparatus, the intermediate transfer belt 107 which is flexible to a transfer drum is used.

The intermediate transfer belt 107 serving as an intermediate element is stretched around the driving shaft roller 107A and a pair of the driven shaft rollers 107B and circulates clockwise while the belt surface between the pair of the driven shaft rollers is in contact with the image bearing member belt 102 covering the exterior of the driving roller 101A from the horizontal direction.

In a case of outputting color images, the toner image of each color formed on the image bearing member belt 102 is transferred onto the intermediate transfer belt 107 each time the toner image is formed to synthesize a color toner image.

This color toner image is transferred at once to a transfer sheet fed from the sheet feeding cassette 106 by the sheet transfer roller 113.

The transfer sheet after the transfer is transferred between the fixing roller 109 and the pressure roller 109A of the fixing device followed by fixing therebetween and discharged to the discharging tray 110.

When the development unit 105A to 105D develops the image with the toner, the concentration of the toner in the development agent accommodated in the development unit lowers.

The decrease of the toner concentration in the development agent is detected by a toner concentration sensor.

If the toner concentration decreases, the toner replenishing devices connected to respective development units operate to supply the toner thereto to increase the toner concentration in the development agent.

A development agent for so-called trickle development in which toner carrier and toner are mixed can be used as the replenishing toner if the development unit has a development agent discharging mechanism

In FIG. 6, the color image is formed by superimposing the toner images on the intermediate transfer belt.

An image forming apparatus having a transfer mechanism in which the toner images are directly transferred from the transfer drum to a recording medium without using the intermediate transfer belt is also within the scope of the present invention.

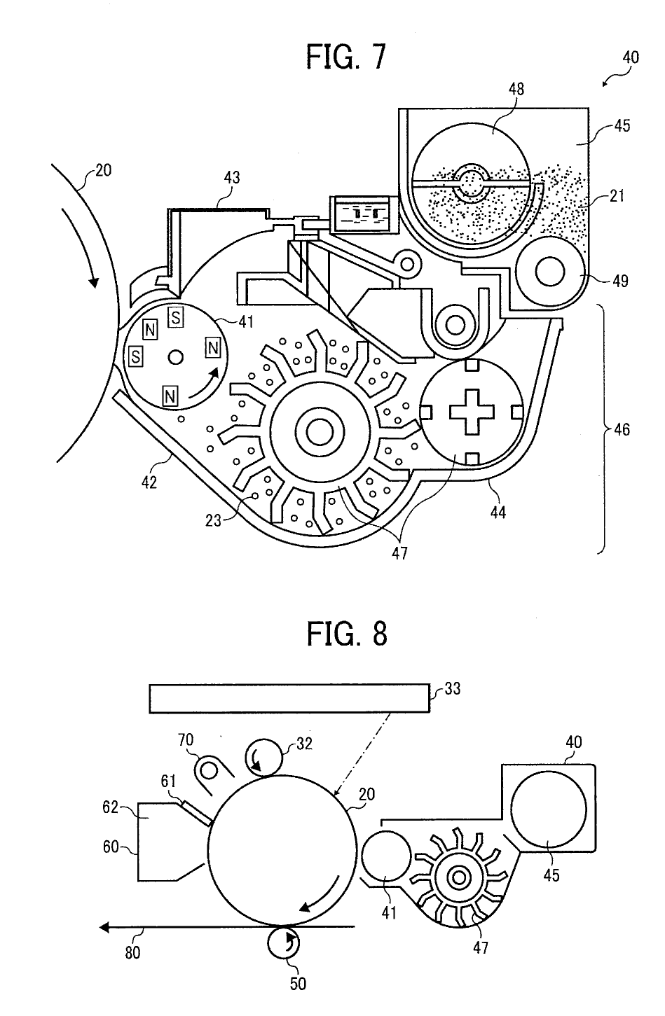

FIG. 7 is a diagram illustrating an example of the development device for use in the present disclosure and variations described later are within the scope of the present invention.

In FIG. 7, a development device 40 arranged opposing an image bearing member 20 serving as the latent image bearing member is formed by a development sleeve 41 serving as the development agent bearing member, a development agent accommodating member 42, a doctor blade 43 serving as a regulating member, a support housing 44, etc.

To the supporting housing 44 having an opening on the side of the image bearing member 20, a toner hopper 45 serving as a toner accommodating unit to accommodate toner 21 therein is connected.

There is provided a development agent stirring mechanism 47 that imparts friction/peeling-off charges to the toner 21 by stirring the toner 21 and a toner carrier 23 to a development agent accommodating unit 46, which accommodates the development agent containing the toner 21 and the toner carrier 23 and is provided adjacent to the toner hopper 45.

A toner agitator 48 serving as a toner supplying device rotated by a driving device and a toner supplying mechanism 49 are arranged inside the toner hopper 45.

The toner agitator 48 and the toner supplying mechanism 49 send out the toner 21 in the toner hopper 45 to the development agent accommodating unit 46.

The development sleeve 41 is arranged in the space between the image bearing member 20 and the toner hopper 45.

The development sleeve 41 rotated in the direction indicated by the arrow in FIG. 7 by a driving device has a magnet therein serving as the magnetic field generator arranged against the development device 40 with their relative positions unchanged to form a magnet brush of the toner carrier 23.

The doctor blade 43 is integrally attached to the development agent accommodating member 42 on the side on which the support housing 44 is not attached.

In this embodiment, the doctor blade 43 is arranged with a gap between the top of the doctor blade 43 and the exterior surface of the development sleeve 41.

Using such a device, the image forming method of the present disclosure is executed in the following manner.

By the configuration described above, the toner 21 sent out from the inside the toner hopper 45 by the toner agitator 48 and the toner supplying mechanism 49 is conveyed to the development agent accommodating unit 46 and stirred by the development agent stirring mechanism 47 to receive desired friction/peeling-off charges.

Thereafter, the toner 21 is transferred to the position facing the exterior surface of the image bearing member 20 while borne on the development sleeve 41 together with the toner carrier 23 as the development agent.

Only the toner 21 is electrostatically bonded with the latent electrostatic image formed on the image bearing member 20 to form a toner image.

FIG. 8 is a diagram illustrating an example of the image forming apparatus having the development device illustrated in FIG. 7.

Around the image bearing member 20 having a drum-like shape, there are arranged a charger 32, an image irradiating unit 33, the development device 40, a transfer device 50, a cleaner 60, and a discharging lamp 70.

In this embodiment, the surface of the charger 32 and the surface of the image bearing member 20 are not in contact with each other but arranged with a gap of about 0.2 mm therebetween.

A voltage application device of the charger 32 charges the image bearing member 20 by an electric field in which an alternating current component is superimposed on a direct current component to reduce uneven charging to the image bearing member 20.

The image forming method including the development method is conducted as follows:

A series of the image forming processes are described based on negative-positive process.

The image bearing member 20 typified by an organic photoconductor (OPC) having an organic electroconductive layer is discharged by the discharging lamp 70, negatively-charged by the charger 32, for example, a charger and a charging roller, evenly followed by forming a latent image by a laser beam emitted from the image irradiating unit 33 such as a laser beam optical system (in this example, the absolute value of the voltage at an irradiated area is lower than the absolute value of the voltage at a non-irradiated area).

The laser beam is emitted from a semiconductor laser and scans the surface of the image bearing member 20 by a polygon mirror having a polygonal column rotating at a high speed in the rotation axis direction of the image bearing member 20.

The thus formed latent image is developed by a development agent formed of a mixture of toner particles and toner carrier particles supplied to the development sleeve 41 serving as a development agent bearing member included in the development device 40 to form a visual toner image.

When the latent image is developed, a voltage application mechanism applies a suitable DC voltage or a development bias in which an AC voltage is superimposed on the suitable DC voltage to the development sleeve 41 between the irradiated portion and the non-irradiated portion of the image bearing member 20.

A transfer medium (typically paper) 80 is fed from a sheet feeding mechanism and sent between the image bearing member 20 and the transfer device 50 in synchronization with the top of the image by a pair of registration rollers arranged top and bottom to transfer the toner image.

A voltage having a polarity reverse to that of the toner charging is preferably applied to the transfer device 50 as a transfer bias.

Thereafter, the intermediate transfer body 80 is separated from the image bearing member 20 to obtain a transfer image.

In addition, the toner particles remaining on the image bearing member 20 are retrieved into a toner collection chamber 62 in the cleaning device 60 by a cleaning blade 61 serving as the cleaner.

The retrieved toner is optionally transferred to the development agent accommodating unit 46 and/or the toner hopper 45 by a toner recycle device for reuse.

The image forming apparatus has a plurality of the development devices described above.

The toner images are sequentially transferred to a transfer medium and sent to a fixing mechanism using heat, etc. to fix the toner directly or by way of an intermediate transfer medium to which the multiple toner images are transferred and from which the transferred image is transferred at once to the transfer medium.

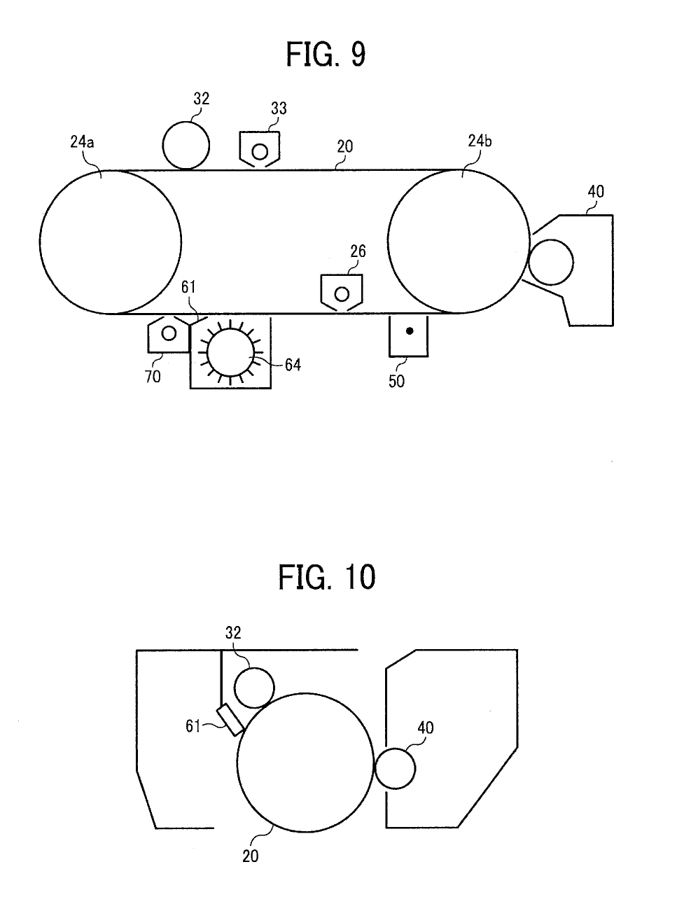

FIG. 9 is a diagram illustrating another example of the image forming apparatus for use in the present disclosure.

The image bearing member 20 has at least a photosensitive layer on an electroconductive substrate.

While the image bearing member 20 is driven by driving rollers 24a and 24b, the following processes of charging by the charger 32; image irradiation by the image irradiating unit 33; development by the development device 40; transfer using the transfer device 50; pre-cleaning irradiation by a pre-cleaning irradiation light source 26; cleaning by the cleaning blade 61; and discharging by the discharging lamp 70, which are executed repeatedly to form images.

In FIG. 9, the pre-cleaning irradiator 26 irradiates the image bearing member 20 (naturally, the substrate is transmissive).

FIG. 10 is a diagram illustrating an example of the process cartridge of the present disclosure. This process cartridge uses the development agent of the present disclosure, integrally has the image bearing member 20, the charger 32 employing a brush contact system, the development device 40, and the cleaning device having the cleaning blade 61 serving as the cleaner, and is detachably attachable to an image forming apparatus.

In the present disclosure, respective elements described above are integrally combined as the process cartridge detachably attachable to an image forming apparatus such as a photocopier and a printer.

Having generally described (preferred embodiments of) this invention, further understanding can be obtained by reference to certain specific examples which are provided herein for the purpose of illustration only and are not intended to be limiting.

In the descriptions in the following examples, the numbers represent weight ratios in parts, unless otherwise specified.

### EXAMPLES

Crystalline Polyester Resin

Manufacture a crystalline polyesters a1 to a6 by using a compound selected from 1,4-butane diol, 1,5-pentane diol, 1,6-hexane diol as the alcohol component and a compound selected from fumaric acid, succinic acid, trimellitic acid, and terephthalic acid as a carboxylic acid.

The crystalline polyesters a1 to a6 have an X-ray diffraction pattern by a powder diffraction device in which at least one diffraction peak is observed at a position of 2θ of from 19° to 25°.

FIG. 4 is a graph illustrating the result of X-ray diffraction of the crystalline resin a6.

The glass transition temperature Tg and the softening temperature T1/2 of the crystalline polyesters a1 to a6 are shown in Table 1.

| | | | Whether the ester |
|---|---|---|---|
| | Glass transition | Softening | bond represented by |
| Crystalline | temperature Tg | temperature T ½ | Chemical structure |
| polyester A | (° C.) | (° C.) | 1 is contained |
| a1 | 98 | 104 | No |
| a2 | 81 | 86 | No |
| a3 | 84 | 89 | No |
| a4 | 116 | 122 | No |
| a5 | 119 | 126 | No |
| a6 | 100 | 106 | Yes |

Non-Crystalline Resin

Conduct estrification reaction of an aromatic diol component and a monomer selected from ethylene glycol, glycerine, adipic acid, terephthalic acid, isophthalic acid, and itaconic acid at normal pressure and 170° C. to 260° C. with no presence of a catalyst, thereafter add antimony trioxide to the reaction system in a ratio of 400 ppm to the total amount of carboxylic acid, and conduct condensation polymerization reaction at 250° C. while removing glycol under a vacuum of 3 Ton out of the system to obtain a resin.

Conduct the cross-linking reaction until the stirring torque is 10 kg·cm (100 ppm) and stop the reaction by releasing the reduced pressure state of the reaction system to obtain non-crystalline resins b1 to b5 and c1 to c3.

The non-crystalline resins b1 to b5 and c1 to c3 has an X-ray diffraction pattern in which no diffraction is observed, meaning that the resins are non-crystalline.

The properties of the non-crystalline resins b1 to b5 and c1 to c3 are shown in Tables 2 and 3.

TABLE 2

| | | | Component |
|---|---|---|---|
| | | | insoluble in |
| Non-crystalline | | Softening | chloroform (% by |
| resin B | material | temperature (° C.) | weight) |
| b1 | Polyester | 140 | 21 |
| b2 | Polyester | 145 | 4 |
| b3 | Polyester | 140 | 6 |
| b4 | Polyester | 151 | 39 |
| b5 | Polyester | 141 | 41 |
| b6 | Styrene-acrylic | 165 | 13 |

TABLE 3

| | | | Glass | Molecular weight | |
|---|---|---|---|---|---|
| Non- | | Softening | transition | distribution | |
| crystalline | | temperature | temperature | Main | Half width |
| resin C | Material | (° C.) | (° C.) | peak | value |
| c1 | polyester | 100 | 63 | 5,000 | 17,000 |
| c2 | Styrene- | 135 | 60 | 14,000 | 31,000 |
| | acrylic | | | | |
| c3 | polyester | 89 | 62 | 4,000 | 13,000 |

Manufacturing of Complex Resin d1

Prepare a complex resin d1 having a softening point of 115° C., a glass transition temperature of 58° C., and an acid value of 25 mgKOH/g using terephthalic acid, fumaric acid, trimellitic acid anhydride, an adduct of bisphenol A with 2,2-propylene oxide, and an adduct of bisphenol A with 2,2-ethylene oxide as a condensation polymerization monomer and styrene, acrylic acid, and 2-ethyl hexyl acrylate as an addition polymerization monomer.

Manufacturing of Complex Resin d2

Prepare a complex resin d2 using hexamethylene diamine and ε-caprolactum as the condensation polymerization monomer and styrene, acrylic acid, and 2-ethylhexyl acrylate as the addition polymerization monomer.

The unit compositions of the complex resins d1 and d2 are shown in Table 4.

TABLE 4

| | Condensation | Addition polymerization |
|---|---|---|
| Complex resin D | polymerization resin unit | resin unit |
| d1 | Polyester-based | Vinyl-based |
| d2 | Polyamide-based | Vinyl-based |

Preparation of Master Batch

| | |
|---|---|
| Non-crystalline resin: c3 | 100 parts |
| Coloring agent: p2 | 50 parts |
| Pure Water: | 50 parts |

Prepare a master batch by preliminary kneading using the recipe specified above.

### Example 1

| | |
|---|---|
| Crystalline polyester resin: a1 | 4 parts |
| Non-crystalline resin: b1 | 35 parts |
| Non-crystalline resin: c1 | 55 parts |
| Complex Resin: d1 | 10 parts |
| Coloring agent: p1 (carbon black) | 14 parts |
| Releasing agent: Carnauba wax (melting point: 81° C.) | 6 parts |
| Charge control agent: monoazo complex | 2 parts |
| (chrome complex salt dye (BONTRON S-34, | |
| manufactured by ORIENT CHEMICAL | |
| INDUSTRIES CO., LTD.) | |

Preliminary mix the recipe specified above by a HENSCHEL mixer (FM20B, manufactured by NIPPON COKE & ENGINEERING. CO., LTD.), melt-knead the mixture by a two-shaft kneader (PCM-30, manufactured by IKEGAI CORP.) at 100° C. to 130° C.

Roll the obtained kneaded mixture to have a thickness of 2.8 mm by a roller and cool down the resultant by a belt cooler to room temperature followed by coarse-pulverization by a hammer mill to 200 μm to 300 μm.

Next, finely pulverize the coarsely-pulverized material by an supersonic pulverizer LABOJET (manufactured by NIPPON PHEUMATIC MEG. CO.) followed by classification by an air classifier (MDS-I, manufactured by NIPPON PHEUMATIC MFG. CO.) while appropriately controlling the louver opening to have particles having a weight average particle diameter of from 5.1 μm to 6.1 μm) to obtain mother toner particles.

Next, stir and mix 100 parts of the mother toner particles with 1.0 part of an additive (HDK-2000, manufactured by CLARIANT JAPAN K.K.) to prepare [Pulverized toner 1].

Uniformly mix [Pulverized toner 1] and coating ferrite carrier with a ratio of 5% by weight to 95% by weight by using a TURBULA® mixer (manufactured by WILLY A. BACHOFEN (WAB) AG) to obtain [Pulverized toner development agent 1].

### Examples 2 to 35 and Comparative Examples 1 to 8

Prepare [Toner 2] to [Toner 43] and [Development agent 2] to [Development agent 43] in the same manner as in Example 1 except that the raw materials are replaced with those shown in Table 5.

Salicylic acid metal compounds of the charge control agents for use in Examples 30 to 35 are a metal complex (BONTRON® E-84, manufactured by ORIENT CHEMICAL INDUSTRIES CO., LTD.) of zinc salicylate.

In addition, use a master batch to prepare [Toner 31] because the dispersion of the pigment in the resin is bad.

With regard to manufacturing toner, based on back calculation of the non-crystalline resin c3 contained in the master batch, control the ratio of the finally blended raw materials as shown in Table 5.

The molecular weight main peak, the half value width of the molecular weight distribution, the DSC peak temperature and endothermic amount ascribable to the crystalline polyester A in the temperature range of from 90° C. to 130° C., whether the diffraction peak is observed in the X-ray diffraction measuring in a range of from 19° to 25°, and the volume average particle diameter of the prepared pulverized toners are shown in Table 6.

TABLE 5

| | | Crystalline | Non-Crystalline | Non-Crystalline | Complex | Coloring |
|---|---|---|---|---|---|---|
| | | polyester A | resin B | resin C | resin D | agent |
| | | Material (parts | Material (parts | Material (parts | Material (parts | Material (parts |
| | | by weight) | by weight) | by weight) | by weight) | by weight) |
| Example 1 | Toner 1 | a1 (4 parts) | b1 (35 parts) | c1 (55 parts) | d1 (10 parts) | p1 (14 parts) |
| Comparative | Toner 2 | None | b1 (35 parts) | c1 (55 parts) | d1 (10 parts) | p1 (14 parts) |
| Example 1 | | | | | | |
| Comparative | Toner 3 | a1 (4 parts) | None | c1 (90 parts) | d1 (10 parts) | p1 (14 parts) |
| Example 2 | | | | | | |
| Comparative | Toner 4 | a1 (4 parts) | b1 (90 parts) | None | d1 (10 parts) | p1 (14 parts) |
| Example 3 | | | | | | |
| Comparative | Toner 5 | a1 (4 parts) | b1 (35 parts) | c1 (55 parts) | None | p1 (14 parts) |
| Example 4 | | | | | | |
| Comparative | Toner 6 | a1 (4 parts) | b1 (35 parts) | c2 (55 parts) | d1 (10 parts) | p1 (14 parts) |
| Example 5 | | | | | | |
| Comparative | Toner 7 | a1 (4 parts) | b1 (45 parts) | c1 (45 parts) | d1 (10 parts) | p1 (14 parts) |
| Example 6 | | | | | | |
| Example 2 | Toner 8 | a1 (4 parts) | b1 (40 parts) | c1 (50 parts) | d1 (10 parts) | p1 (14 parts) |
| Example 3 | Toner 9 | a1 (4 parts) | b1 (25 parts) | c1 (65 parts) | d1 (10 parts) | p1 (14 parts) |
| Comparative | Toner 10 | a1 (4 parts) | b1 (20 parts) | c1 (70 parts) | d1 (10 parts) | p1 (14 parts) |
| Example 7 | | | | | | |
| Example 4 | Toner 11 | a1 (4 parts) | b1 (28 parts) | c1 (62 parts) | d1 (5 parts) | p1 (14 parts) |
| Comparative | Toner 12 | a1 (4 parts) | b1 (30 parts) | c1 (60 parts) | d1 (5 parts) | p1 (14 parts) |
| Example 8 | | | | | | |
| Example 5 | Toner 13 | a2 (4 parts) | b1 (35 parts) | c1 (55 parts) | d1 (10 parts) | p1 (14 parts) |
| Example 6 | Toner 14 | a3 (4 parts) | b1 (35 parts) | c1 (55 parts) | d1 (10 parts) | p1 (14 parts) |
| Example 7 | Toner 15 | a4 (4 parts) | b1 (35 parts) | c1 (55 parts) | d1 (10 parts) | p1 (14 parts) |
| Example 8 | Toner 16 | a5 (4 parts) | b1 (35 parts) | c1 (55 parts) | d1 (10 parts) | p1 (14 parts) |
| Example 9 | Toner 17 | a1 (1 part) | b1 (35 parts) | c1 (55 parts) | d1 (10 parts) | p1 (14 parts) |
| Example 10 | Toner 18 | a1 (2 parts) | b1 (35 parts) | c1 (55 parts) | d1 (10 parts) | p1 (14 parts) |
| Example 11 | Toner 19 | a1 (16 parts) | b1 (35 parts) | c1 (55 parts) | d1 (10 parts) | p1 (14 parts) |
| Example 12 | Toner 20 | a1 (19 parts) | b1 (35 parts) | c1 (55 parts) | d1 (10 parts) | p1 (14 parts) |
| Example 13 | Toner 21 | a1 (4 parts) | b1 (35 parts) | c3 (55 parts) | d1 (10 parts) | p1 (14 parts) |
| Example 14 | Toner 22 | a1 (4 parts) | b1 (35 parts) | c3 (55 parts) | d1 (10 parts) | p1 (14 parts) |
| Example 15 | Toner 23 | a1 (4 parts) | b2 (35 parts) | c3 (55 parts) | d1 (10 parts) | p1 (14 parts) |
| Example 16 | Toner 24 | a1 (4 parts) | b3 (35 parts) | c3 (55 parts) | d1 (10 parts) | p1 (14 parts) |
| Example 17 | Toner 25 | a1 (4 parts) | b4 (35 parts) | c3 (55 parts) | d1 (10 parts) | p1 (14 parts) |
| Example 18 | Toner 26 | a1 (4 parts) | b5 (35 parts) | c3 (55 parts) | d1 (10 parts) | p1 (14 parts) |
| Example 19 | Toner 27 | a1 (4 parts) | b3 (10 parts) | c3 (80 parts) | d1 (10 parts) | p1 (14 parts) |
| Example 20 | Toner 28 | a1 (4 parts) | b3 (15 parts) | c3 (75 parts) | d1 (10 parts) | p1 (14 parts) |
| Example 21 | Toner 29 | a1 (4 parts) | b4 (15 parts) | c3 (75 parts) | d1 (10 parts) | p1 (14 parts) |
| Example 22 | Toner 30 | a1 (4 parts) | b4 (20 parts) | c3 (70 parts) | d1 (10 parts) | p1 (14 parts) |
| Example 23 | Toner 31 | a1 (4 parts) | b1 (35 parts) | c3 (55 parts) | d1 (10 parts) | p2 (14 parts) |
| Example 24 | Toner 32 | a1 (4 parts) | b6 (35 parts) | c2 (55 parts) | d1 (10 parts) | p1 (14 parts) |
| Example 25 | Toner 33 | a1 (4 parts) | b6 (35 parts) | c3 (55 parts) | d1 (10 parts) | p1 (14 parts) |
| Example 26 | Toner 34 | a1 (4 parts) | b1 (35 parts) | c3 (55 parts) | d1 (10 parts) | p1 (14 parts) |
| Example 27 | Toner 35 | a6 (1 part) | b1 (35 parts) | c3 (55 parts) | d1 (10 parts) | p1 (14 parts) |
| Example 28 | Toner 36 | a6 (4 parts) | b1 (35 parts) | c3 (55 parts) | d2 (10 parts) | p1 (14 parts) |
| Example 29 | Toner 37 | a1 (1 part) | b1 (35 parts) | c3 (55 parts) | d1 (10 parts) | p1 (14 parts) |
| Example 30 | Toner 38 | a6 (4 parts) | b1 (35 parts) | c3 (55 parts) | d1 (10 parts) | p1 (14 parts) |
| Example 31 | Toner 39 | a6 (4 parts) | b1 (35 parts) | c3 (55 parts) | d1 (10 parts) | p1 (14 parts) |
| Example 32 | Toner 40 | a6 (4 parts) | b1 (35 parts) | c3 (55 parts) | d1 (10 parts) | p1 (14 parts) |
| Example 33 | Toner 41 | a6 (4 parts) | b1 (35 parts) | c3 (55 parts) | d1 (10 parts) | p1 (14 parts) |
| Example 34 | Toner 42 | a6 (4 parts) | b1 (35 parts) | c3 (55 parts) | d1 (10 parts) | p1 (14 parts) |
| Example 35 | Toner 43 | a6 (4 parts) | b1 (35 parts) | c3 (55 parts) | d1 (10 parts) | p1 (14 parts) |

TABLE 6

| | | | Charge | | |
|---|---|---|---|---|---|
| | | | control | | Thickness |
| | | Releasing | agent | Aliphatic | of cooled |
| | | agent | Material | acid amide | kneaded |
| | | Material (parts | (parts by | (parts by | material |
| | | by weight) | weight) | weight) | (mm) |
| Example 1 | Toner 1 | Carnauba wax | Monoazo | None | 2.8 |
| | | (6 parts) | metal | | |
| | | | complex (2 | | |
| | | | parts) | | |
| Comparative | Toner 2 | Carnauba wax | Monoazo | None | 2.8 |
| Example 1 | | (6 parts) | metal | | |
| | | | complex (2 | | |
| | | | parts) | | |
| Comparative | Toner 3 | Carnauba wax | Monoazo | None | 2.8 |
| Example 2 | | (6 parts) | metal | | |
| | | | complex (2 | | |
| | | | parts) | | |
| Comparative | Toner 4 | Carnauba wax | Monoazo | None | 2.8 |
| Example 3 | | (6 parts) | metal | | |
| | | | complex (2 | | |
| | | | parts) | | |
| Comparative | Toner 5 | Carnauba wax | Monoazo | None | 2.8 |
| Example 4 | | (6 parts) | metal | | |
| | | | complex (2 | | |
| | | | parts) | | |
| Comparative | Toner 6 | Carnauba wax | Monoazo | None | 2.8 |
| Example 5 | | (6 parts) | metal | | |
| | | | complex (2 | | |
| | | | parts) | | |
| Comparative | Toner 7 | Carnauba wax | Monoazo | None | 2.8 |
| Example 6 | | (6 parts) | metal | | |
| | | | complex (2 | | |
| | | | parts) | | |
| Example 2 | Toner 8 | Carnauba wax | Monoazo | None | 2.8 |
| | | (6 parts) | metal | | |
| | | | complex (2 | | |
| | | | parts) | | |
| Example 3 | Toner 9 | Carnauba wax | Monoazo | None | 2.8 |
| | | (6 parts) | metal | | |
| | | | complex (2 | | |
| | | | parts) | | |
| Comparative | Toner 10 | Carnauba wax | Monoazo | None | 2.8 |
| Example 7 | | (6 parts) | metal | | |
| | | | complex (2 | | |
| | | | parts) | | |
| Example 4 | Toner 11 | Carnauba wax | Monoazo | None | 2.8 |
| | | (6 parts) | metal | | |
| | | | complex (2 | | |
| | | | parts) | | |
| Comparative | Toner 12 | Carnauba wax | Monoazo | None | 2.8 |
| Example 8 | | (6 parts) | metal | | |
| | | | complex (2 | | |
| | | | parts) | | |
| Example 5 | Toner 13 | Carnauba wax | Monoazo | None | 2.8 |
| | | (6 parts) | metal | | |
| | | | complex (2 | | |
| | | | parts) | | |
| Example 6 | Toner 14 | Carnauba wax | Monoazo | None | 2.8 |
| | | (6 parts) | metal | | |
| | | | complex (2 | | |
| | | | parts) | | |
| Example 7 | Toner 15 | Carnauba wax | Monoazo | None | 2.8 |
| | | (6 parts) | metal | | |
| | | | complex (2 | | |
| | | | parts) | | |
| Example 8 | Toner 16 | Carnauba wax | Monoazo | None | 2.8 |
| | | (6 parts) | metal | | |
| | | | complex (2 | | |
| | | | parts) | | |
| Example 9 | Toner 17 | Carnauba wax | Monoazo | None | 2.8 |
| | | (6 parts) | metal | | |
| | | | complex (2 | | |
| | | | parts) | | |
| Example 10 | Toner 18 | Carnauba wax | Monoazo | None | 2.8 |
| | | (6 parts) | metal | | |
| | | | complex (2 | | |
| | | | parts) | | |
| Example 11 | Toner 19 | Carnauba wax | Monoazo | None | 2.8 |
| | | (6 parts) | metal | | |
| | | | complex (2 | | |
| | | | parts) | | |
| Example 12 | Toner 20 | Carnauba wax | Monoazo | None | 2.8 |
| | | (6 parts) | metal | | |
| | | | complex (2 | | |
| | | | parts) | | |
| Example 13 | Toner 21 | Carnauba wax | Monoazo | None | 2.8 |
| | | (6 parts) | metal | | |
| | | | complex (2 | | |
| | | | parts) | | |
| Example 14 | Toner 22 | Carnauba wax | Monoazo | N,N′- | 2.8 |
| | | (6 parts) | metal | ethylene-bis | |
| | | | complex (2 | stearyl acid | |
| | | | parts) | amide (2 | |
| | | | | parts) | |
| Example 15 | Toner 23 | Carnauba wax | Monoazo | N,N′- | 2.8 |
| | | (6 parts) | metal | ethylene-bis | |
| | | | complex (2 | stearyl acid | |
| | | | parts) | amide (2 | |
| | | | | parts) | |
| Example 16 | Toner 24 | Carnauba wax | Monoazo | N,N′- | 2.8 |
| | | (6 parts) | metal | ethylene-bis | |
| | | | complex (2 | stearyl acid | |
| | | | parts) | amide (2 | |
| | | | | parts) | |
| Example 17 | Toner 25 | Carnauba wax | Monoazo | N,N′- | 2.8 |
| | | (6 parts) | metal | ethylene-bis | |
| | | | complex (2 | stearyl acid | |
| | | | parts) | amide (2 | |
| | | | | parts) | |
| Example 18 | Toner 26 | Carnauba wax | Monoazo | N,N′- | 2.8 |
| | | (6 parts) | metal | ethylene-bis | |
| | | | complex (2 | stearyl acid | |
| | | | parts) | amide (2 | |
| | | | | parts) | |
| Example 19 | Toner 27 | Carnauba wax | Monoazo | N,N′- | 2.8 |
| | | (6 parts) | metal | ethylene-bis | |
| | | | complex (2 | stearyl acid | |
| | | | parts) | amide (2 | |
| | | | | parts) | |
| Example 20 | Toner 28 | Carnauba wax | Monoazo | N,N′- | 2.8 |
| | | (6 parts) | metal | ethylene-bis | |
| | | | complex (2 | stearyl acid | |
| | | | parts) | amide (2 | |
| | | | | parts) | |
| Example 21 | Toner 29 | Carnauba wax | Monoazo | N,N′- | 2.8 |
| | | (6 parts) | metal | ethylene-bis | |
| | | | complex (2 | stearyl acid | |
| | | | parts) | amide (2 | |
| | | | | parts) | |
| Example 22 | Toner 30 | Carnauba wax | Monoazo | N,N′- | 2.8 |
| | | (6 parts) | metal | ethylene-bis | |
| | | | complex (2 | stearyl acid | |
| | | | parts) | amide (2 | |
| | | | | parts) | |
| Example 23 | Toner 31 | Carnauba wax | Monoazo | N,N′- | 2.8 |
| | | (6 parts) | metal | ethylene-bis | |
| | | | complex (2 | stearyl acid | |
| | | | parts) | amide (2 | |
| | | | | parts) | |
| Example 24 | Toner 32 | Carnauba wax | Monoazo | N,N′- | 2.8 |
| | | (6 parts) | metal | ethylene-bis | |
| | | | complex (2 | stearyl acid | |
| | | | parts) | amide (2 | |
| | | | | parts) | |
| Example 25 | Toner 33 | Carnauba wax | Monoazo | N,N′- | 2.8 |
| | | (6 parts) | metal | ethylene-bis | |
| | | | complex (2 | stearyl acid | |
| | | | parts) | amide (2 | |
| | | | | parts) | |
| Example 26 | Toner 34 | Polyethylene | Monoazo | N,N′- | 2.8 |
| | | wax (6 parts) | metal | ethylene-bis | |
| | | | complex (2 | stearyl acid | |
| | | | parts) | amide (2 | |
| | | | | parts) | |
| Example 27 | Toner 35 | Carnauba wax | Monoazo | N,N′- | 2.8 |
| | | (6 parts) | metal | ethylene-bis | |
| | | | complex (2 | stearyl acid | |
| | | | parts) | amide (2 | |
| | | | | parts) | |
| Example 28 | Toner 36 | Carnauba wax | Monoazo | N,N′- | 2.8 |
| | | (6 parts) | metal | ethylene-bis | |
| | | | complex (2 | stearyl acid | |
| | | | parts) | amide (2 | |
| | | | | parts) | |
| Example 29 | Toner 37 | Carnauba wax | Monoazo | N,N′- | 2.6 |
| | | (6 parts) | metal | ethylene-bis | |
| | | | complex (2 | stearyl acid | |
| | | | parts) | amide (2 | |
| | | | | parts) | |
| Example 30 | Toner 38 | Carnauba wax | Salicylic | N,N′- | 2.8 |
| | | (6 parts) | acid metal | ethylene-bis | |
| | | | compound | stearyl acid | |
| | | | (2 parts) | amide (2 | |
| | | | | parts) | |
| Example 31 | Toner 39 | Carnauba wax | Salicylic | N,N′- | 2.8 |
| | | (6 parts) | acid metal | ethylene-bis | |
| | | | compound | stearyl acid | |
| | | | (2 parts) | amide (2 | |
| | | | | parts) | |
| Example 32 | Toner 40 | Carnauba wax | Salicylic | N,N′- | 2.8 |
| | | (6 parts) | acid metal | ethylene-bis | |
| | | | compound | stearyl acid | |
| | | | (2 parts) | amide (2 | |
| | | | | parts) | |
| Example 33 | Toner 41 | Carnauba wax | Salicylic | N,N′- | 2.8 |
| | | (6 parts) | acid metal | ethylene-bis | |
| | | | compound | stearyl acid | |
| | | | (2 parts) | amide (2 | |
| | | | | parts) | |
| Example 34 | Toner 42 | Carnauba wax | Salicylic | N,N′- | 2.2 |
| | | (6 parts) | acid metal | ethylene-bis | |
| | | | compound | stearyl acid | |
| | | | (2 parts) | amide (2 | |
| | | | | parts) | |
| Example 35 | Toner 43 | Carnauba wax | Salicylic | N,N′- | 2.8 |
| | | (6 parts) | acid metal | ethylene-bis | |
| | | | compound | stearyl acid | |
| | | | (2 parts) | amide (2 | |
| | | | | parts) | |

| | | Crystalline | Non-crystalline | Non-crystalline | Complex | Coloring |
|---|---|---|---|---|---|---|
| | | polyester A | polyester B | polyester C | resin D | agent |
| Example 1 | Toner 1 | a1 | b1 | c1 | d1 | p1 |
| Comparative | Toner 2 | None | b1 | c1 | d1 | p1 |
| Example 1 | | | | | | |
| Comparative | Toner 3 | a1 | None | c1 | d1 | p1 |
| Example 2 | | | | | | |
| Comparative | Toner 4 | a1 | b1 | None | d1 | p1 |
| Example 3 | | | | | | |
| Comparative | Toner 5 | a1 | b1 | c1 | None | p1 |
| Example 4 | | | | | | |
| Comparative | Toner 6 | a1 | b1 | c2 | d1 | p1 |
| Example 5 | | | | | | |
| Comparative | Toner 7 | a1 | b1 | c1 | d1 | p1 |
| Example 6 | | | | | | |
| Example 2 | Toner 8 | a1 | b1 | c1 | d1 | p1 |
| Example 3 | Toner 9 | a1 | b1 | c1 | d1 | p1 |
| Comparative | Toner 10 | a1 | b1 | c1 | d1 | p1 |
| Example 7 | | | | | | |
| Example 4 | Toner 11 | a1 | b1 | c1 | d1 | p1 |
| Comparative | Toner 12 | a1 | b1 | c1 | d1 | p1 |
| Example 8 | | | | | | |
| Example 5 | Toner 13 | a2 | b1 | c1 | d1 | p1 |
| Example 6 | Toner 14 | a3 | b1 | c1 | d1 | p1 |
| Example 7 | Toner 15 | a4 | b1 | c1 | d1 | p1 |
| Example 8 | Toner 16 | a5 | b1 | c1 | d1 | p1 |
| Example 9 | Toner 17 | a1 | b1 | c1 | d1 | p1 |
| Example 10 | Toner 18 | a1 | b1 | c1 | d1 | p1 |
| Example 11 | Toner 19 | a1 | b1 | c1 | d1 | p1 |
| Example 12 | Toner 20 | a1 | b1 | c1 | d1 | p1 |
| Example 13 | Toner 21 | a1 | b1 | c3 | d1 | p1 |
| Example 14 | Toner 22 | a1 | b1 | c3 | d1 | p1 |
| Example 15 | Toner 23 | a1 | b2 | c3 | d1 | p1 |
| Example 16 | Toner 24 | a1 | b3 | c3 | d1 | p1 |
| Example 17 | Toner 25 | a1 | b4 | c3 | d1 | p1 |
| Example 18 | Toner 26 | a1 | b5 | c3 | d1 | p1 |
| Example 19 | Toner 27 | a1 | b3 | c3 | d1 | p1 |
| Example 20 | Toner 28 | a1 | b3 | c3 | d1 | p1 |
| Example 21 | Toner 29 | a1 | b4 | c3 | d1 | p1 |
| Example 22 | Toner 30 | a1 | b4 | c3 | d1 | p1 |
| Example 23 | Toner 31 | a1 | b1 | c3 | d1 | p2 |
| Example 24 | Toner 32 | a1 | b6 | c2 | d1 | p1 |
| Example 25 | Toner 33 | a1 | b6 | c3 | d1 | p1 |
| Example 26 | Toner 34 | a1 | b1 | c3 | d1 | p1 |
| Example 27 | Toner 35 | a6 | b1 | c3 | d1 | p1 |
| Example 28 | Toner 36 | a6 | b1 | c3 | d2 | p1 |
| Example 29 | Toner 37 | a1 | b1 | c3 | d1 | p1 |
| Example 30 | Toner 38 | a6 | b1 | c3 | d1 | p1 |
| Example 31 | Toner 39 | a6 | b1 | c3 | d1 | p2 |
| Example 32 | Toner 40 | a6 | b1 | c3 | d1 | p1 |
| Example 33 | Toner 41 | a6 | b1 | c3 | d1 | p1 |
| Example 34 | Toner 42 | a6 | b1 | c3 | d1 | p1 |
| Example 35 | Toner 43 | a6 | b1 | c3 | d1 | p1 |

| | | | | | Endothermic | |
|---|---|---|---|---|---|---|
| | | | Toner | DSC peak | amount of DSC | |
| | | Toner | molecular | temperature | peak in the | |
| | | molecular | weight | (° C.) in the | range of from | |
| | | weight | half value | range of from | 90° C. to 130° C. | |
| | | main peak | width | 90° C. to 130° C. | (J/g) | Releasing agent |
| Example 1 | Toner 1 | 7,400 | 13,000 | 108 | 5 | Carnauba wax |
| Comparative | Toner 2 | 7,400 | 13,000 | None | None | Carnauba wax |
| Example 1 | | | | | | |
| Comparative | Toner 3 | 7,400 | 13,000 | 108 | 5 | Carnauba wax |
| Example 2 | | | | | | |
| Comparative | Toner 4 | 7,600 | 105,000 | 108 | 5 | Carnauba wax |
| Example 3 | | | | | | |
| Comparative | Toner 5 | 7,400 | 13,000 | 108 | 5 | Carnauba wax |
| Example 4 | | | | | | |
| Comparative | Toner 6 | 9,500 | 14,000 | 108 | 5 | Carnauba wax |
| Example 5 | | | | | | |
| Comparative | Toner 7 | 900 | 9,000 | 108 | 5 | Carnauba wax |
| Example 6 | | | | | | |
| Example 2 | Toner 8 | 1,100 | 10,000 | 108 | 5 | Carnauba wax |
| Example 3 | Toner 9 | 9,800 | 13,800 | 108 | 5 | Carnauba wax |
| Comparative | Toner 10 | 11,000 | 14,100 | 108 | 5 | Carnauba wax |
| Example 7 | | | | | | |
| Example 4 | Toner 11 | 8,800 | 14,500 | 108 | 5 | Carnauba wax |
| Comparative | Toner 12 | 9,000 | 16,000 | 108 | 5 | Carnauba wax |
| Example 8 | | | | | | |
| Example 5 | Toner 13 | 7,400 | 13,000 | 88 | 5 | Carnauba wax |
| Example 6 | Toner 14 | 7,400 | 13,000 | 92 | 5 | Carnauba wax |
| Example 7 | Toner 15 | 7,400 | 13,000 | 127 | 5 | Carnauba wax |
| Example 8 | Toner 16 | 7,400 | 13,000 | 131 | 5 | Carnauba wax |
| Example 9 | Toner 17 | 7,400 | 13,000 | 108 | 0.5 | Carnauba wax |
| Example 10 | Toner 18 | 7,400 | 13,000 | 108 | 2 | Carnauba wax |
| Example 11 | Toner 19 | 7,400 | 13,000 | 108 | 14 | Carnauba wax |
| Example 12 | Toner 20 | 7,400 | 13,000 | 108 | 16 | Carnauba wax |
| Example 13 | Toner 21 | 7,000 | 13,000 | 108 | 5 | Carnauba wax |
| Example 14 | Toner 22 | 6,500 | 13,000 | 108 | 5 | Carnauba wax |
| Example 15 | Toner 23 | 3,400 | 8,900 | 108 | 5 | Carnauba wax |
| Example 16 | Toner 24 | 3,800 | 9,500 | 108 | 5 | Carnauba wax |
| Example 17 | Toner 25 | 7,500 | 13,100 | 108 | 5 | Carnauba wax |
| Example 18 | Toner 26 | 8,000 | 13,400 | 108 | 5 | Carnauba wax |
| Example 19 | Toner 27 | 3,500 | 8,500 | 108 | 5 | Carnauba wax |
| Example 20 | Toner 28 | 4,000 | 9,000 | 108 | 5 | Carnauba wax |
| Example 21 | Toner 29 | 9,300 | 12,800 | 108 | 5 | Carnauba wax |
| Example 22 | Toner 30 | 9,500 | 13,000 | 108 | 5 | Carnauba wax |
| Example 23 | Toner 31 | 7,000 | 12,500 | 108 | 5 | Carnauba wax |
| Example 24 | Toner 32 | 9,000 | 13,500 | 108 | 5 | Carnauba wax |
| Example 25 | Toner 33 | 7,700 | 13,000 | 108 | 5 | Carnauba wax |
| Example 26 | Toner 34 | 6,900 | 12,500 | 108 | 5 | Polyethylene wax |
| Example 27 | Toner 35 | 7,200 | 12,500 | 110 | 5 | Carnauba wax |
| Example 28 | Toner 36 | 7,000 | 12,500 | 110 | 5 | Carnauba wax |
| Example 29 | Toner 37 | 6,000 | 12,500 | 108 | 2 | Carnauba wax |
| Example 30 | Toner 38 | 7,000 | 12,500 | 110 | 5 | Carnauba wax |
| Example 31 | Toner 39 | 7,000 | 12,500 | 110 | 5 | Carnauba wax |
| Example 32 | Toner 40 | 7,000 | 12,500 | 110 | 5 | Carnauba wax |
| Example 33 | Toner 41 | 7,000 | 12,500 | 110 | 5 | Carnauba wax |
| Example 34 | Toner 42 | 7,000 | 12,500 | 110 | 3 | Carnauba wax |
| Example 35 | Toner 43 | 7,000 | 12,500 | 110 | 5 | Carnauba wax |

| | | | | X-ray | |
|---|---|---|---|---|---|
| | | | | diffraction | |
| | | | | peak in | Volume |
| | | | | the range | average |
| | | Charge | Aliphatic | of from | particle |
| | | control | amide | 19° to | diameter |
| | | agent | compound | 25° | (μm) |
| Example 1 | Toner 1 | Monoazo | No | Yes | 6.5 |
| | | metal | | | |
| | | complex | | | |
| Comparative | Toner 2 | Monoazo | No | No | 6.5 |
| Example 1 | | metal | | | |
| | | complex | | | |
| Comparative | Toner 3 | Monoazo | No | Yes | 6.5 |
| Example 2 | | metal | | | |
| | | complex | | | |
| Comparative | Toner 4 | Monoazo | No | Yes | 6.5 |
| Example 3 | | metal | | | |
| | | complex | | | |
| Comparative | Toner 5 | Monoazo | No | Yes | 6.5 |
| Example 4 | | metal | | | |
| | | complex | | | |
| Comparative | Toner 6 | Monoazo | No | Yes | 6.5 |
| Example 5 | | metal | | | |
| | | complex | | | |
| Comparative | Toner 7 | Monoazo | No | Yes | 6.5 |
| Example 6 | | metal | | | |
| | | complex | | | |
| Example 2 | Toner 8 | Monoazo | No | Yes | 6.5 |
| | | metal | | | |
| | | complex | | | |
| Example 3 | Toner 9 | Monoazo | No | Yes | 6.5 |
| | | metal | | | |
| | | complex | | | |
| Comparative | Toner | Monoazo | No | Yes | 6.5 |
| Example 7 | 10 | metal | | | |
| | | complex | | | |
| Example 4 | Toner | Monoazo | No | Yes | 6.5 |
| | 11 | metal | | | |
| | | complex | | | |
| Comparative | Toner | Monoazo | No | Yes | 6.5 |
| Example 8 | 12 | metal | | | |
| | | complex | | | |
| Example 5 | Toner | Monoazo | No | Yes | 6.5 |
| | 13 | metal | | | |
| | | complex | | | |
| Example 6 | Toner | Monoazo | No | Yes | 6.5 |
| | 14 | metal | | | |
| | | complex | | | |
| Example 7 | Toner | Monoazo | No | Yes | 6.5 |
| | 15 | metal | | | |
| | | complex | | | |
| Example 8 | Toner | Monoazo | No | Yes | 6.5 |
| | 16 | metal | | | |
| | | complex | | | |
| Example 9 | Toner | Monoazo | No | Yes | 6.5 |
| | 17 | metal | | | |
| | | complex | | | |
| Example 10 | Toner | Monoazo | No | Yes | 6.5 |
| | 18 | metal | | | |
| | | complex | | | |
| Example 11 | Toner | Monoazo | No | Yes | 6.5 |
| | 19 | metal | | | |
| | | complex | | | |
| Example 12 | Toner | Monoazo | No | Yes | 6.5 |
| | 20 | metal | | | |
| | | complex | | | |
| Example 13 | Toner | Monoazo | No | Yes | 6.5 |
| | 21 | metal | | | |
| | | complex | | | |
| Example 14 | Toner | Monoazo | Yes | Yes | 6.5 |
| | 22 | metal | | | |
| | | complex | | | |
| Example 15 | Toner | Monoazo | Yes | Yes | 6.5 |
| | 23 | metal | | | |
| | | complex | | | |
| Example 16 | Toner | Monoazo | Yes | Yes | 6.5 |
| | 24 | metal | | | |
| | | complex | | | |
| Example 17 | Toner | Monoazo | Yes | Yes | 6.5 |
| | 25 | metal | | | |
| | | complex | | | |
| Example 18 | Toner | Monoazo | Yes | Yes | 6.5 |
| | 26 | metal | | | |
| | | complex | | | |
| Example 19 | Toner | Monoazo | Yes | Yes | 6.5 |
| | 27 | metal | | | |
| | | complex | | | |
| Example 20 | Toner | Monoazo | Yes | Yes | 6.5 |
| | 28 | metal | | | |
| | | complex | | | |
| Example 21 | Toner | Monoazo | Yes | Yes | 6.5 |
| | 29 | metal | | | |
| | | complex | | | |
| Example 22 | Toner | Monoazo | Yes | Yes | 6.5 |
| | 30 | metal | | | |
| | | complex | | | |
| Example 23 | Toner | Monoazo | Yes | Yes | 6.5 |
| | 31 | metal | | | |
| | | complex | | | |
| Example 24 | Toner | Monoazo | Yes | Yes | 6.5 |
| | 32 | metal | | | |
| | | complex | | | |
| Example 25 | Toner | Monoazo | Yes | Yes | 6.5 |
| | 33 | metal | | | |
| | | complex | | | |
| Example 26 | Toner | Monoazo | Yes | Yes | 6.5 |
| | 34 | metal | | | |
| | | complex | | | |
| Example 27 | Toner | Monoazo | Yes | Yes | 6.5 |
| | 35 | metal | | | |
| | | complex | | | |
| Example 28 | Toner | Monoazo | Yes | Yes | 6.5 |
| | 36 | metal | | | |
| | | complex | | | |
| Example 29 | Toner | Monoazo | Yes | No | 6.5 |
| | 37 | metal | | | |
| | | complex | | | |
| Example 30 | Toner | Salicylic | Yes | Yes | 3.8 |
| | 38 | acid metal | | | |
| | | compound | | | |
| Example 31 | Toner | Salicylic | Yes | Yes | 4.2 |
| | 39 | acid metal | | | |
| | | compound | | | |
| Example 32 | Toner | Salicylic | Yes | Yes | 9.0 |
| | 40 | acid metal | | | |
| | | compound | | | |
| Example 33 | Toner | Salicylic | Yes | Yes | 11.0 |
| | 41 | acid metal | | | |
| | | compound | | | |
| Example 34 | Toner | Salicylic | Yes | Yes | 6.5 |
| | 42 | acid metal | | | |
| | | compound | | | |
| Example 35 | Toner | Salicylic | Yes | Yes | 6.5 |
| | 43 | acid metal | | | |
| | | compound | | | |

Form images with the development agents 1 to 43 by using an image forming apparatus remodeled based on the image forming apparatus illustrated in FIG. 6 in such a manner that the fixing device is replaced with the fixing device illustrated in FIG. 1 or the fixing device illustrated in FIG. 2 in the development unit 105D.

The development units 105A to 105C are not used.

Low Temperature Fixability, Hot Offset Resistance, Fine-Line Reproducibility (Initial)

Output images with the development agents 1 to 43 using the image forming apparatus described above.

Output solid images having an attachment amount of 0.4 mg/cm² through the processes of irradiation, development, and transfer on paper (Type 6200, manufactured by RICOH CO., LTD.)

The linear speed of the fixing is 160 mm/s.

Output the image sequentially while changing the fixing temperature with a gap of 5° C. to measure the lowest fixing temperature (low temperature fixability) below which cold offset occurs and the highest fixing temperature (hot offset resistance) above which hot offset occurs.

Output a text image having about 2 mm×about 2 mm per letter with an image ratio of 5% at 20° C. higher than the lowest fixing temperature using the pulverized toner and observe the image with naked eyes to evaluate the fine line reproducibility.

Low Temperature Fixability
E (Excellent): lower than 130° C.
G (Good): 130° C. to lower than 140° C.
A (Average): 140° C. to lower than 150° C.
F (Fair): 150° C. to lower than 160° C.
B (Bad): 160° C. or higher

Hot Offset Resistance
E (Excellent): 200° C. or higher
G (Good): 190° C. to lower than 200° C.
A (Average): 180° C. to lower than 190° C.
F (Fair): 170° C. to lower than 180° C.
B (Bad): lower than 170° C.

Fine Line Reproducibility
E (Excellent): Extremely excellent
G (Good): Good
A (Average): Normal level
F (Fair): No practical problem
B (Bad): Unacceptable

Smear Resistance

At the lowest fixing temperature, output a half tone image having an amount of toner attachment of from 0.30 mg/cm² to 0.50 mg/cm² with an image ratio of 60% on paper (Type 6200, manufactured by RICOH CO., LTD.) and rub the fixed image portion by white cotton cloth (JIS L0803, cotton No. 3) ten times using a clock meter to measure an ID (hereinafter referred to as smear ID) of the contamination attached to the cloth).

Measure the smear ID by a colorimeter (X-Rite 938).
Measure the color of [Pulverized toner 31] by cyan and others by black.
E (Excellent): Smear ID is 0.20 or less
G (Good): Smear ID is from 0.21 to 0.35
F (Fair): Smear ID is from 0.36 to 0.55
B (Bad): Smear ID is 0.56 or higher

Fine Line Reproducibility (with Time)

After the evaluation of the fine line reproducibility (initial), continuously output chart images having an image area ratio of 5% with a run length of 100,000 sheets while replenishing the toner.

Thereafter, output a text image having about 2 mm×about 2 mm per letter with an image ratio of 5% at 20° C. higher than the lowest fixing temperature using the pulverized toner and observe the image with naked eyes to evaluate the fine line reproducibility with time.

The evaluation criteria are the same as the fine line reproducibility (initial).

High Temperature Stability

Place 10 g of each toner in a bottle followed by tapping 100 times by a tapping machine. Preserve it in a constant temperature at 50° C. for 24 hours followed by cooling down to room temperature.

Measure the penetration degree of the toner by a penetration tester to evaluate the high temperature stability of the toner.
E (Excellent): Penetrated through
G (Good): 20 mm or more
A (Average): 15 mm to less than 20 mm
F (Fair): 10 mm to less than 15 mm
B (Bad): less than 10 mm

The evaluation results are shown in Table 7.

TABLE 7

| | | Fixing device illustrated in FIG. 2 | | |
|---|---|---|---|---|
| | | Low | | |
| | Toner | temperature | Hot offset | Smear |
| | No. | fixability | resistance | resistance |
| Example 1 | 1 | E | G | G |
| Comparative | 2 | B | E | G |
| Example 1 | | | | |
| Comparative | 3 | E | B | E |
| Example 2 | | | | |
| Comparative | 4 | B | E | G |
| Example 3 | | | | |
| Comparative | 5 | E | G | G |
| Example 4 | | | | |
| Comparative | 6 | B | G | G |
| Example 5 | | | | |
| Comparative | 7 | E | B | E |
| Example 6 | | | | |
| Example 2 | 8 | E | A | G |
| Example 3 | 9 | A | G | G |
| Comparative | 10 | B | G | F |
| Example 7 | | | | |
| Example 4 | 11 | A | G | G |
| Comparative | 12 | B | G | F |
| Example 8 | | | | |
| Example 5 | 13 | E | F | G |
| Example 6 | 14 | G | G | G |
| Example 7 | 15 | G | G | G |
| Example 8 | 16 | A | G | G |
| Example 9 | 17 | E | G | G |
| Example 10 | 18 | E | G | G |
| Example 11 | 19 | E | G | G |
| Example 12 | 20 | E | G | E |
| Example 13 | 21 | G | G | G |
| Example 14 | 22 | E | G | E |
| Example 15 | 23 | G | A | E |
| Example 16 | 24 | E | A | E |
| Example 17 | 25 | G | E | E |
| Example 18 | 26 | A | E | E |
| Example 19 | 27 | E | A | E |
| Example 20 | 28 | E | G | E |
| Example 21 | 29 | G | E | E |
| Example 22 | 30 | A | E | E |
| Example 23 | 31 | E | G | E |
| Example 24 | 32 | G | A | E |
| Example 25 | 33 | E | G | E |
| Example 26 | 34 | E | A | G |
| Example 27 | 35 | E | G | E |
| Example 28 | 36 | E | G | E |
| Example 29 | 37 | G | G | E |
| Example 30 | 38 | E | E | E |
| Example 31 | 39 | E | E | E |
| Example 32 | 40 | E | E | E |
| Example 33 | 41 | E | E | E |
| Example 34 | 42 | E | E | E |
| Example 35 | 43 | E | E | E |

| | | Fixing device illustrated in FIG. 1 | | |
|---|---|---|---|---|
| | | Low | | |
| | Toner | temperature | Hot offset | Smear |
| | No. | fixability | resistance | resistance |
| Example 1 | 1 | B | A | F |
| Comparative | 2 | B | A | B |
| Example 1 | | | | |
| Comparative | 3 | G | B | F |
| Example 2 | | | | |
| Comparative | 4 | B | G | B |
| Example 3 | | | | |
| Comparative | 5 | F | A | F |
| Example 4 | | | | |
| Comparative | 6 | B | F | B |
| Example 5 | | | | |
| Comparative | 7 | A | B | F |
| Example 6 | | | | |
| Example 2 | 8 | B | F | F |
| Example 3 | 9 | B | F | B |
| Comparative | 10 | B | F | B |
| Example 7 | | | | |
| Example 4 | 11 | B | F | B |
| Comparative | 12 | B | F | B |
| Example 8 | | | | |
| Example 5 | 13 | F | B | B |
| Example 6 | 14 | F | B | B |
| Example 7 | 15 | B | F | B |
| Example 8 | 16 | B | F | B |
| Example 9 | 17 | F | F | B |
| Example 10 | 18 | F | F | B |
| Example 11 | 19 | F | F | B |
| Example 12 | 20 | F | F | B |
| Example 13 | 21 | A | F | B |
| Example 14 | 22 | G | B | G |
| Example 15 | 23 | G | B | G |
| Example 16 | 24 | G | B | G |
| Example 17 | 25 | B | A | F |
| Example 18 | 26 | B | A | F |
| Example 19 | 27 | G | B | G |
| Example 20 | 28 | G | B | G |
| Example 21 | 29 | B | G | F |
| Example 22 | 30 | B | G | B |
| Example 23 | 31 | A | B | G |
| Example 24 | 32 | B | F | B |
| Example 25 | 33 | A | B | G |
| Example 26 | 34 | A | B | G |
| Example 27 | 35 | F | F | B |
| Example 28 | 36 | F | F | B |
| Example 29 | 37 | B | F | B |
| Example 30 | 38 | A | G | B |
| Example 31 | 39 | F | G | B |
| Example 32 | 40 | F | G | B |
| Example 33 | 41 | F | G | B |
| Example 34 | 42 | A | F | B |
| Example 35 | 43 | F | G | B |

| Toner | | |
|---|---|---|
| | Fine line | |
| Toner | reproducibility | Hot offset |

| | No. | Initial | With time | resistance |
|---|---|---|---|---|
| Example 1 | 1 | E | E | G |
| Comparative | 2 | E | E | F |
| Example 1 | | | | |
| Comparative | 3 | E | G | B |
| Example 2 | | | | |
| Comparative | 4 | E | E | G |
| Example 3 | | | | |
| Comparative | 5 | G | F | B |
| Example 4 | | | | |
| Comparative | 6 | E | E | A |
| Example 5 | | | | |
| Comparative | 7 | E | G | B |
| Example 6 | | | | |
| Example 2 | 8 | E | G | A |
| Example 3 | 9 | E | E | G |
| Comparative | 10 | E | E | G |
| Example 7 | | | | |
| Example 4 | 11 | E | E | G |
| Comparative | 12 | E | E | G |
| Example 8 | | | | |
| Example 5 | 13 | E | E | F |
| Example 6 | 14 | E | E | A |
| Example 7 | 15 | E | E | G |
| Example 8 | 16 | E | E | G |
| Example 9 | 17 | E | E | F |
| Example 10 | 18 | E | E | A |
| Example 11 | 19 | E | E | A |
| Example 12 | 20 | E | E | F |
| Example 13 | 21 | E | E | A |
| Example 14 | 22 | E | E | G |
| Example 15 | 23 | E | G | A |
| Example 16 | 24 | E | G | A |
| Example 17 | 25 | E | E | E |
| Example 18 | 26 | E | E | E |
| Example 19 | 27 | E | G | F |
| Example 20 | 28 | E | G | F |
| Example 21 | 29 | E | E | E |
| Example 22 | 30 | E | E | E |
| Example 23 | 31 | E | E | G |
| Example 24 | 32 | E | E | E |
| Example 25 | 33 | E | E | E |
| Example 26 | 34 | E | E | G |
| Example 27 | 35 | E | E | E |
| Example 28 | 36 | A | F | A |
| Example 29 | 37 | G | G | F |
| Example 30 | 38 | A | F | E |
| Example 31 | 39 | G | A | E |
| Example 32 | 40 | G | G | E |
| Example 33 | 41 | A | A | E |
| Example 34 | 42 | E | E | G |
| Example 35 | 43 | E | E | E |

As described above, the present invention provides an image forming method and an image forming apparatus that produce quality images having excellent low temperature fixability, high temperature stability, and hot offset resistance at a high speed while achieving the energy saving by a combination of the particular toner and the particular fixing device.

Having now fully described embodiments of the present invention, it will be apparent to one of ordinary skill in the art that many changes and modifications can be made thereto without departing from the spirit and scope of embodiments of the invention as set forth herein.

What is claimed is:

1. An image forming method comprising steps of:
forming a latent electrostatic image on an image bearing member;
developing the latent electrostatic image with a development agent comprising toner to obtain a toner image;
transferring the toner image onto a transfer medium;
fixing the toner image on the transfer medium;
wherein the step of fixing is executed by a fixing device comprising:
a heating roller;
a fixing roller having an elastic layer, which is arranged in parallel with the heating roller;
a toner heating medium having an endless form stretched around the heating roller and the fixing roller; and
a pressure roller having an elastic layer, which presses the fixing roller via the toner heating medium and while rotating to form a nipping portion with the fixing roller,
wherein the toner comprises:
a toner binder comprising:
a crystalline resin comprising:
a polyester resin A having a crystallinity;
a non-crystalline resin comprising:
a non-crystalline resin B comprising:
a component insoluble in chloroform; and
a non-crystalline resin C having a softening point (T1/2) 25° C. or more lower than that of the non-crystalline resin B; and
a complex resin comprising:
a complex resin D comprising:
a condensation polymerization resin unit; and
an addition polymerization resin unit,
wherein the toner has a main peak in a range of from 1,000 to 10,000 in a molecule weight distribution as measured for a component soluble in tetrahydrofuran (THF) by gel permeation chromatography (GPC) with a half value width of 15,000 or less.

2. The image forming method according to claim 1, wherein the heating roller and/or the toner heating medium are heated by electromagnetic induction.

3. The image forming method according to claim 1, wherein the toner has an endothermic peak in a range of from 90° C. to 130° C. as measured for the endothermic peak by differential scanning calorimetry (DSC).

4. The image forming method according to claim 3, wherein the toner has an endothermic amount of an endothermic peak of from 1 J/g to 15 J/g as measured for the endothermic peak by DSC.

5. The image forming method according to claim 1, wherein the non-crystalline resin C has a main peak in a range of from 1,000 to 10,000 in a molecule weight distribution as measured for a component soluble in THF by GPC with a half value width of 15,000 or less.

6. The image forming method according to claim 1, wherein the non-crystalline resin B comprises a component insoluble in chloroform accounting for 5% by weigh to 40% by weight.

7. The image forming method according to claim 1, wherein the crystalline resin A comprises an ester bond represented by the following Chemical Structure 1 in a molecular main chain.
[—OCO—R—COO—(CH₂)ₙ—] Chemical Structure 1

8. The image forming method according to claim 1, wherein the complex resin D comprises a condensation polymerization polyester resin unit and an addition polymerization vinyl resin unit.

9. An image forming apparatus comprising:
an image bearing member to bear a latent electrostatic image;
an irradiator to irradiate the image bearing member to form the latent electrostatic image thereon;
a development device to develop the latent electrostatic image with a development agent comprising toner to obtain a toner image;
a transfer device to transfer the toner image onto a transfer medium; and
a fixing device to fix the toner image on the transfer medium;
wherein the fixing device comprises:
a heating roller;
a fixing roller having an elastic layer, which is arranged in parallel with the heating roller;
a toner heating medium having an endless form stretched around the heating roller and the fixing roller; and
a pressure roller having an elastic layer, which presses the fixing roller via the toner heating medium while rotating to form a nipping portion with the fixing roller,
wherein the toner comprises:
a toner binder comprising:
a crystalline resin comprising:
a polyester resin A having a crystallinity;
a non-crystalline resin comprising:
a non-crystalline resin B comprising:
a component insoluble in chloroform; and
a non-crystalline resin C having a softening point (T1/2) 25° C. or more lower than that of the non-crystalline resin B; and
a complex resin comprising a complex resin D comprising:
a condensation polymerization resin unit; and
an addition polymerization resin unit,
wherein the toner has a main peak in a range of from 1,000 to 10,000 in a molecule weight distribution as measured for a component soluble in tetrahydrofuran (THF) by gel permeation chromatography (GPC) with a half value width of 15,000 or less.
